(19) United States
(12) Patent Application Publication
(10) Pub. No.: US 2026/0059532 A1
(43) Pub. Date: Feb. 26, 2026

(54) METHODS AND APPARATUSES FOR TRANSFORM PRECODING ON A PUSCH

(71) Applicant: LENOVO (BEIJING) LIMITED, Beijing (CN)

(72) Inventors: Ruixiang Ma, Beijing (CN); Yuantao Zhang, Beijing (CN); Hongmei Liu, Beijing (CN); Zhi Yan, Beijing (CN); Haiming Wang, Beijing (CN)

(21) Appl. No.: 19/104,654

(22) PCT Filed: Aug. 19, 2022
(86) PCT No.: PCT/CN2022/113599

§ 371 Date: Feb. 18, 2025

(51) Int. Cl. H04W 72/21; H04W 72/0453

(52) U.S. Cl. CPC H04W 72/21; H04W 72/0453

(57) ABSTRACT

Embodiments of the present disclosure relate to methods and apparatuses for transform precoding on a physical uplink shared channel (PUSCH). According to some embodiments of the disclosure, a user equipment (UE) may include a processor and a transceiver coupled to the processor; and the processor is configured to: receive signaling indicating switching from a transform precoding state to another transform precoding state, wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain; determine whether the signaling takes effect or not for the one or more PUSCH transmissions of the PUSCH repetition or the TBoMS; and transmit the one or more PUSCH transmissions of the PUSCH repetition or the TBoMS in accordance with the first transform precoding state or the second transform precoding state based at least in part on the determination.

### TECHNICAL FIELD

Embodiments of the present disclosure generally relate to wireless communication technology, and more particularly to methods and apparatuses for transform precoding on a physical uplink shared channel (PUSCH).

### BACKGROUND

Wireless communication systems are widely deployed to provide various telecommunication services, such as telephony, video, data, messaging, broadcasts, and so on. Wireless communication systems may employ multiple access technologies capable of supporting communication with multiple users by sharing available system resources (e.g., time, frequency, and power). Examples of wireless communication systems may include fourth generation (4G) systems, such as long term evolution (LTE) systems, LTE-advanced (LTE-A) systems, or LTE-A Pro systems, and fifth generation (5G) systems which may also be referred to as new radio (NR) systems.

In a wireless communication system, a user equipment (UE) may transmit data signals to a base station (BS) via a PUSCH. Various waveforms, including for example, a discrete Fourier transform-spread orthogonal frequency division multiplexing (DFT-s-OFDM) waveform and a cyclic prefix orthogonal frequency division multiplexing (CP-OFDM) waveform, may be dynamically applied to a PUSCH transmission. Different waveforms may be advantageous in different scenarios. However, details regarding a UE's behavior for transform precoding on a PUSCH of a PUSCH repetition or a transmission block processing over multiple slots (TBoMS) has not been discussed yet.

### SUMMARY

Some embodiments of the present disclosure provide a UE. The UE includes a processor and a transceiver coupled to the processor; and the processor is configured to: receive signaling indicating switching from a first transform precoding state to a second transform precoding state, wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain; determine whether the signaling takes effect or not for the one or more PUSCH transmissions of the PUSCH repetition or the TBoMS; and transmit the one or more PUSCH transmissions of the PUSCH repetition or the TBoMS in accordance with the first transform precoding state or the second transform precoding state based at least in part on the determination.

Some embodiments of the present disclosure provide a UE. The UE includes a processor and a transceiver coupled to the processor; and the processor is configured to: receive signaling indicating switching from a first transform precoding state to a second transform precoding state, wherein the signaling would take effect from one physical uplink shared channel (PUSCH) transmission of a PUSCH repetition or a transmission block processing over multiple slots (TBoMS), wherein the one PUSCH transmission of the PUSCH repetition or the TBoMS is after a PUSCH transmission of the PUSCH repetition or the TBoMS firstly appeared in a time domain; determine whether the signaling takes effect or not from the one PUSCH transmission of the PUSCH repetition or the TBoMS; and transmit one or more PUSCH transmissions of the PUSCH repetition or the TBoMS in accordance with the first transform precoding state or the second transform precoding state based at least in part on the determination.

In some embodiments, the first transform precoding state or the second transform precoding state is one of an enabled state and a disabled state.

In some embodiments, a PUSCH transmission of the one or more PUSCH transmissions of the PUSCH repetition is: a PUSCH transmission of PUSCH repetition Type A scheduled by a downlink control information (DCI) format; a PUSCH transmission of PUSCH repetition Type A with a configured grant (CG); or a PUSCH transmission of PUSCH repetition Type B.

In some embodiments, the one PUSCH transmission of the PUSCH repetition is: a PUSCH transmission of PUSCH repetition Type A scheduled by a downlink control information (DCI) format; a PUSCH transmission of PUSCH repetition Type A with a configured grant (CG); or a PUSCH transmission of PUSCH repetition Type B.

In some embodiments, in response to receiving two or more messages including the signaling which would take effect for the one or more PUSCH transmissions of the PUSCH repetition or the TBoMS, determining whether the signaling takes effect or not comprises only determining whether the signaling included in a message lastly received by the UE within the two or more messages takes effect or not, and wherein the signaling included in the two or more messages other than the message does not take effect.

In some embodiments, in response to receiving two or more messages including the signaling which would take effect from the one PUSCH transmissions of the PUSCH repetition or the TBoMS, determining whether the signaling takes effect or not comprises only determining whether the signaling included in a message lastly received by the UE within the two or more messages takes effect or not, and wherein the signaling included in the two or more messages other than the message does not take effect.

In some embodiments, the processor of the UE is configured to: in response to determining that the signaling takes effect, switch from the first transform precoding state to the second transform precoding state for the one or more PUSCH transmissions of the PUSCH repetition or the TBoMS; or in response to determining that the signaling does not take effect, transmit the one or more PUSCH transmissions of the PUSCH repetition or the TBoMS without switching from the first transform precoding state to the second transform precoding state.

In some embodiments, to determine whether the signaling takes effect or not, the processor of the UE is configured to perform one of: determining that the signaling does not take effect for the one or more PUSCH transmissions of the PUSCH repetition or the TBoMS; ignoring the signaling; determining that the signaling takes effect for the one or more PUSCH transmissions of the PUSCH repetition or the TBOMS.

In some embodiments, in response to determining that the signaling does not take effect, the signaling takes effect after a last PUSCH transmission of the PUSCH repetition or the TBOMS.

In some embodiments, in response to determining that the signaling takes effect for the one or more PUSCH transmissions of the PUSCH repetition or the TBoMS, the processor of the UE is configured to redetermine one or more transmission parameters for the one or more PUSCH transmissions of the PUSCH repetition or the TBOMS.

In some embodiments, the one or more transmission parameters include at least one of: a frequency domain resource assignment type; a frequency hopping flag; a sounding reference signal (SRS) resource indicator; a second SRS resource indicator, precoding information and a number of layers; one or more antenna ports; a phase tracking reference signal demodulation reference signal (PTRS-DMRS) association; a beta offset indicator; or a value of demodulation reference signal (DMRS) sequence initialization.

In some embodiments, in response to determining that the signaling takes effect for the one or more PUSCH transmissions of the PUSCH repetition or the TBoMS, a first set of transmission parameters for the one or more PUSCH transmissions are same as a second set of transmission parameters for a PUSCH transmission of the PUSCH repetition or the TBoMS preceding the one or more PUSCH transmissions.

In some embodiments, the first set of transmission parameters or the second set of transmission parameters includes at least one of: a frequency domain resource assignment type; a frequency hopping flag; a PTRS-DMRS association; a value of DMRS sequence initialization; or a modulation and coding scheme (MCS) value.

In some embodiments, determining that the signaling takes effect for the one or more PUSCH transmissions of the PUSCH repetition or the TBoMS is in response to fulfillment of a first set of conditions.

In some embodiments, the processor of the UE is configured to determine whether a first set of conditions is fulfilled or not before determining whether the signaling takes effect or not.

In some embodiments, the first set of conditions includes at least one of: reception of an indication for indicating that the signaling should take effect; a frequency domain resource assignment type of the PUSCH transmission of the PUSCH repetition or the TBoMS firstly appeared in the time domain is not resource allocation type 0; a demodulation reference signal (DMRS) scrambling identifier (ID) for the first transform precoding state is same as a DMRS scrambling ID for the second transform precoding state; a value of DMRS sequence initialization for the first transform precoding state is same as a value of DMRS sequence initialization for the second transform precoding state; a modulation and coding scheme (MCS) value for the first transform precoding state is same as a MCS value for the second transform precoding state; a frequency hopping flag for the first transform precoding state is same as a frequency hopping flag for the second transform precoding state; a SRS resource indicator for the first transform precoding state is same as a SRS resource indicator for the second transform precoding state; a second SRS resource indicator for the first transform precoding state is same as a second SRS resource indicator for the second transform precoding state; precoding information and a number of layers for the first transform precoding state is same as precoding information and a number of layers for the second transform precoding state; one or more antenna ports for the first transform precoding state are same as one or more antenna ports for the second transform precoding state; a PTRS-DMRS association for the first transform precoding state is same as a PTRS-DMRS association for the second transform precoding state; or a beta offset indicator for the first transform precoding state is same as a beta offset indicator for the second transform precoding state.

In some embodiments, the processor of the UE is configured to: determine one or more time domain windows (TDW) s for bundling multiple demodulation reference signals (DMRS) s of PUSCH transmissions of the PUSCH repetition or the TBoMS by taking the switching from the first transform precoding state to the second transform precoding state as an event which causes power consistency and phase continuity not to be maintained across the PUSCH transmissions of the PUSCH repetition or the TBoMS.

In some embodiments, the processor of the UE is configured to take switching from the first transform precoding state to the second transform precoding state as a semi static event or a dynamic event.

In some embodiments, the processor of the UE is configured to: determine whether a second set of conditions is fulfilled; and in response to fulfillment of the second set of conditions, determine to take the switching from the first transform precoding state to the second transform precoding state as the event.

In some embodiments, the second set of conditions includes at least one of: reception of an indication for indicating that the switching from the first transform precoding state to the second transform precoding state is the event; a frequency domain resource assignment type of the PUSCH transmission of the PUSCH repetition or the TBoMS firstly appeared in the time domain is resource allocation type 0; a demodulation reference signal (DMRS) scrambling identifier (ID) for the first transform precoding state is different from a DMRS scrambling ID for the second transform precoding state; a value of DMRS sequence initialization for the first transform precoding state is different from a value of DMRS sequence initialization for the second transform precoding state; a modulation and coding scheme (MCS) value for the first transform precoding state is different from a MCS value for the second transform precoding state; a frequency hopping flag for the first transform precoding state is different from a frequency hopping flag for the second transform precoding state; a SRS resource indicator for the first transform precoding state is different from a SRS resource indicator for the second transform precoding state; a second SRS resource indicator for the first transform precoding state is different from a second SRS resource indicator for the second transform precoding state; precoding information and a number of layers for the first transform precoding state is different from precoding information and a number of layers for the second transform precoding state; one or more antenna ports for the first transform precoding state are different from one or more antenna ports for the second transform precoding state; a PTRS-DMRS association for the first transform precoding state is different from a PTRS-DMRS association for the second transform precoding state; or a beta offset indicator for the first transform precoding state is different from a beta offset indicator for the second transform precoding state.

Some embodiments of the present disclosure provide a network node (e.g., a BS). The network node includes a processor and a transceiver coupled to the processor; and the processor is configured to: transmit signaling indicating switching from a first transform precoding state to a second transform precoding state via the transceiver to a user equipment (UE), wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain; determine whether the signaling takes effect or not for the one or more PUSCH transmissions of the PUSCH repetition or the TBoMS; and receive the one or more PUSCH transmissions of the PUSCH repetition or the TBoMS in accordance with the first transform precoding state or the second transform precoding state based at least in part on the determination via the transceiver from the UE.

Some embodiments of the present disclosure provide a network node (e.g., a BS). The network node includes a processor and a transceiver coupled to the processor; and the processor is configured to: transmit signaling indicating switching from a first transform precoding state to a second transform precoding state via the transceiver to a user equipment (UE), wherein the signaling would take effect from one physical uplink shared channel (PUSCH) transmission of a PUSCH repetition or a transmission block processing over multiple slots (TBoMS), wherein the one PUSCH transmission of the PUSCH repetition or the TBoMS is after a PUSCH transmission of the PUSCH repetition or the TBoMS firstly appeared in a time domain; determine whether the signaling takes effect or not from the one PUSCH transmission of the PUSCH repetition or the TBoMS; and receive one or more PUSCH transmissions of the PUSCH repetition or the TBoMS in accordance with the first transform precoding state or the second transform precoding state based at least in part on the determination via the transceiver from the UE.

In some embodiments, the first transform precoding state or the second transform precoding state is one of an enabled state and a disabled state.

In some embodiments, a PUSCH transmission of the one or more PUSCH transmissions of the PUSCH repetition is: a PUSCH transmission of PUSCH repetition Type A scheduled by a downlink control information (DCI) format; a PUSCH transmission of PUSCH repetition Type A with a configured grant (CG); or a PUSCH transmission of PUSCH repetition Type B.

In some embodiments, the one PUSCH transmission of the PUSCH repetition is: a PUSCH transmission of PUSCH repetition Type A scheduled by a downlink control information (DCI) format; a PUSCH transmission of PUSCH repetition Type A with a configured grant (CG); or a PUSCH transmission of PUSCH repetition Type B.

In some embodiments, in response to transmitting two or more messages including the signaling which would take effect for the one or more PUSCH transmissions of the PUSCH repetition or the TBoMS, determining whether the signaling takes effect or not comprises only determining whether the signaling included in a message lastly transmitted by the network node within the two or more messages takes effect or not, and wherein the signaling included in the two or more messages other than the message does not take effect.

In some embodiments, in response to transmitting two or more messages including the signaling which would take effect from the one PUSCH transmission of the PUSCH repetition or the TBoMS, determining whether the signaling takes effect or not comprises only determining whether the signaling included in a message lastly transmitted by the network node within the two or more messages takes effect or not, and wherein the signaling included in the two or more messages other than the message does not take effect.

In some embodiments, the processor of the network node is configured to: in response to determining that the signaling takes effect, switch from the first transform precoding state to the second transform precoding state for the one or more PUSCH transmissions of the PUSCH repetition or the TBoMS; or in response to determining that the signaling does not take effect, receive the one or more PUSCH transmissions of the PUSCH repetition or the TBoMS without switching from the first transform precoding state to the second transform precoding state.

In some embodiments, to determine whether the signaling takes effect or not, the processor of the network node is configured to perform one of: determining that the signaling does not take effect for the one or more PUSCH transmissions of the PUSCH repetition or the TBoMS; ignoring the signaling; determining that the signaling takes effect for the one or more PUSCH transmissions of the PUSCH repetition or the TBOMS.

In some embodiments, in response to determining that the signaling does not take effect, the signaling takes effect after a last PUSCH transmission of the PUSCH repetition or the TBoMS.

In some embodiments, in response to determining that the signaling takes effect for the one or more PUSCH transmissions of the PUSCH repetition or the TBoMS, the processor of the network node is configured to redetermine one or more transmission parameters for the one or more PUSCH transmissions of the PUSCH repetition or the TBoMS.

In some embodiments, the one or more transmission parameters include at least one of: a frequency domain resource assignment type; a frequency hopping flag; a sounding reference signal (SRS) resource indicator; a second SRS resource indicator, precoding information and a number of layers; one or more antenna ports; a phase tracking reference signal demodulation reference signal (PTRS-DMRS) association; a beta offset indicator; or a value of demodulation reference signal (DMRS) sequence initialization.

In some embodiments, in response to determining that the signaling takes effect for the one or more PUSCH transmissions of the PUSCH repetition or the TBoMS, a first set of transmission parameters for the one or more PUSCH transmissions are same as a second set of transmission parameters for a PUSCH transmission of the PUSCH repetition or the TBoMS preceding the one or more PUSCH transmissions.

In some embodiments, the first set of transmission parameters or the second set of transmission parameters includes at least one of: a frequency domain resource assignment type; a frequency hopping flag; a PTRS-DMRS association; a value of DMRS sequence initialization; or a modulation and coding scheme (MCS) value.

In some embodiments, determining that the signaling takes effect for the one or more PUSCH transmissions of the PUSCH repetition or the TBoMS is in response to fulfillment of a first set of conditions.

In some embodiments, the processor of the network node is configured to determine whether a first set of conditions is fulfilled or not before determining whether the signaling takes effect or not.

In some embodiments, the first set of conditions includes at least one of: transmitting an indication for indicating that the signaling should take effect; a frequency domain resource assignment type of the PUSCH transmission of the PUSCH repetition or the TBoMS firstly appeared in the time domain is not resource allocation type 0; a demodulation reference signal (DMRS) scrambling identifier (ID) for the first transform precoding state is same as a DMRS scrambling ID for the second transform precoding state; a value of DMRS sequence initialization for the first transform precoding state is same as a value of DMRS sequence initialization for the second transform precoding state; a modulation and coding scheme (MCS) value for the first transform precoding state is same as a MCS value for the second transform precoding state; a frequency hopping flag for the first transform precoding state is same as a frequency hopping flag for the second transform precoding state; a SRS resource indicator for the first transform precoding state is same as a SRS resource indicator for the second transform precoding state; a second SRS resource indicator for the first transform precoding state is same as a second SRS resource indicator for the second transform precoding state; precoding information and a number of layers for the first transform precoding state is same as precoding information and a number of layers for the second transform precoding state; one or more antenna ports for the first transform precoding state are same as one or more antenna ports for the second transform precoding state; a PTRS-DMRS association for the first transform precoding state is same as a PTRS-DMRS association for the second transform precoding state; or a beta offset indicator for the first transform precoding state is same as a beta offset indicator for the second transform precoding state.

In some embodiments, the processor of the network node is configured to: determine one or more time domain windows (TDW) s for bundling multiple demodulation reference signals (DMRS) s of PUSCH transmissions of the PUSCH repetition or the TBoMS by taking the switching from the first transform precoding state to the second transform precoding state as an event which causes power consistency and phase continuity not to be maintained across the PUSCH transmissions of the PUSCH repetition or the TBoMS.

In some embodiments, the processor of the network node is configured to take switching from the first transform precoding state to the second transform precoding state as a semi static event or a dynamic event.

In some embodiments, the processor of the network node is configured to: determine whether a second set of conditions is fulfilled; and in response to fulfillment of the second set of conditions, determine to take the switching from the first transform precoding state to the second transform precoding state as the event.

In some embodiments, the second set of conditions includes at least one of: transmitting an indication for indicating that the switching from the first transform precoding state to the second transform precoding state is the event; a frequency domain resource assignment type of the PUSCH transmission of the PUSCH repetition or the TBoMS firstly appeared in the time domain is resource allocation type 0; a demodulation reference signal (DMRS) scrambling identifier (ID) for the first transform precoding state is different from a DMRS scrambling ID for the second transform precoding state; a value of DMRS sequence initialization for the first transform precoding state is different from a value of DMRS sequence initialization for the second transform precoding state; a modulation and coding scheme (MCS) value for the first transform precoding state is different from a MCS value for the second transform precoding state; a frequency hopping flag for the first transform precoding state is different from a frequency hopping flag for the second transform precoding state; a SRS resource indicator for the first transform precoding state is different from a SRS resource indicator for the second transform precoding state; a second SRS resource indicator for the first transform precoding state is different from a second SRS resource indicator for the second transform precoding state; precoding information and a number of layers for the first transform precoding state is different from precoding information and a number of layers for the second transform precoding state; one or more antenna ports for the first transform precoding state are different from one or more antenna ports for the second transform precoding state; a PTRS-DMRS association for the first transform precoding state is different from a PTRS-DMRS association for the second transform precoding state; or a beta offset indicator for the first transform precoding state is different from a beta offset indicator for the second transform precoding state.

In some embodiments, the processor of the network node is configured to transmit, via the transceiver to the UE, at least one of: the indication for indicating that the signaling should take effect; or the indication for indicating that the switching from the first transform precoding state to the second transform precoding state is the event.

Some embodiments of the present disclosure provide a method performed by a UE. The method may include: receiving signaling indicating switching from a first transform precoding state to a second transform precoding state, wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain; determining whether the signaling takes effect or not for the one or more PUSCH transmissions of the PUSCH repetition or the TBoMS; and transmitting the one or more PUSCH transmissions of the PUSCH repetition or the TBoMS in accordance with the first transform precoding state or the second transform precoding state based at least in part on the determination.

Some embodiments of the present disclosure provide a method performed by a UE. The method may include: receiving signaling indicating switching from a first transform precoding state to a second transform precoding state, wherein the signaling would take effect from one physical uplink shared channel (PUSCH) transmission of a PUSCH repetition or a transmission block processing over multiple slots (TBoMS), wherein the one PUSCH transmission of the PUSCH repetition or the TBoMS is after a PUSCH transmission of the PUSCH repetition or the TBoMS firstly appeared in a time domain; determining whether the signaling takes effect or not from the one PUSCH transmission of the PUSCH repetition or the TBoMS; and transmitting one or more PUSCH transmissions of the PUSCH repetition or the TBoMS in accordance with the first transform precoding state or the second transform precoding state based at least in part on the determination.

Some embodiments of the present disclosure provide a method performed by a network node (e.g., a BS). The method may include: transmitting signaling indicating switching from a first transform precoding state to a second transform precoding state via the transceiver to a user equipment (UE), wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain; determining whether the signaling takes effect or not for the one or more PUSCH transmissions of the PUSCH repetition or the TBoMS; and receiving the one or more PUSCH transmissions of the PUSCH repetition or the TBoMS in accordance with the first transform precoding state or the second transform precoding state based at least in part on the determination from the UE.

Some embodiments of the present disclosure provide a method performed by a network node (e.g., a BS). The method may include: transmitting signaling indicating switching from a first transform precoding state to a second transform precoding state via the transceiver to a user equipment (UE), wherein the signaling would take effect from one physical uplink shared channel (PUSCH) transmission of a PUSCH repetition or a transmission block processing over multiple slots (TBoMS), wherein the one PUSCH transmission of the PUSCH repetition or the TBoMS is after a PUSCH transmission of the PUSCH repetition or the TBoMS firstly appeared in a time domain; determining whether the signaling takes effect or not from the one PUSCH transmission of the PUSCH repetition or the TBoMS; and receiving one or more PUSCH transmissions of the PUSCH repetition or the TBoMS in accordance with the first transform precoding state or the second transform precoding state based at least in part on the determination from the UE.

Some embodiments of the present disclosure also provide an apparatus for wireless communications. The apparatus includes: a non-transitory computer-readable medium having stored thereon computer-executable instructions; a receiving circuitry; a transmitting circuitry; and a processor coupled to the non-transitory computer-readable medium, the receiving circuitry and the transmitting circuitry, wherein the computer-executable instructions cause the processor to implement any of the above-mentioned methods performed by a UE or a network node (e.g., a BS).

The details of one or more examples are set forth in the accompanying drawings and the descriptions below. Other features, objects, and advantages will be apparent from the descriptions and drawings, and from the claims.

### BRIEF DESCRIPTION OF THE DRAWINGS

In order to describe the manner in which the advantages and features of the disclosure can be obtained, a description of the disclosure is rendered by reference to specific embodiments thereof, which are illustrated in the appended drawings. These drawings depict only exemplary embodiments of the disclosure and are not therefore to be considered limiting of its scope.

FIG. 1 illustrates a schematic diagram of a wireless communication system according to some embodiments of the present disclosure.

FIG. 2 illustrates an example for a PUSCH transmission with PUSCH repetition Type A according to some embodiments of the present disclosure.

FIG. 3 illustrates an example for a PUSCH transmission with PUSCH repetition Type B according to some embodiments of the present disclosure.

FIG. 4 illustrates an example for a PUSCH transmission with enhanced PUSCH repetition Type A according to some embodiments of the present disclosure.

FIG. 5 illustrates an example for a PUSCH transmission with TBoMS according to some embodiments of the present disclosure.

FIG. 6 illustrates an example for a PUSCH transmission with TDW according to some embodiments of the present disclosure.

FIG. 7 illustrates a flowchart of an exemplary procedure for switching transform precoding states according to some embodiments of the present disclosure.

FIG. 8 illustrates an example for determining whether signaling takes effect according to some embodiments of the present disclosure.

FIG. 9 illustrates a further flowchart of an exemplary procedure for switching transform precoding states according to some embodiments of the present disclosure.

FIG. 10 a block diagram of an exemplary apparatus according to some embodiments of the present disclosure.

### DETAILED DESCRIPTION

The detailed description of the appended drawings is intended as a description of the preferred embodiments of the present disclosure and is not intended to represent the only form in which the present disclosure may be practiced. It should be understood that the same or equivalent functions may be accomplished by different embodiments that are intended to be encompassed within the spirit and scope of the present disclosure.

Reference will now be made in detail to some embodiments of the present disclosure, examples of which are illustrated in the accompanying drawings. To facilitate understanding, embodiments are provided under a specific network architecture(s) and new service scenarios, such as the 3rd generation partnership project (3GPP) 5G (NR), 3GPP long-term evolution (LTE) Release 8, and so on. It is contemplated that along with the developments of network architectures and new service scenarios, all embodiments in the present disclosure are also applicable to similar technical problems; and moreover, the terminologies recited in the present disclosure may change, which should not affect the principles of the present disclosure.

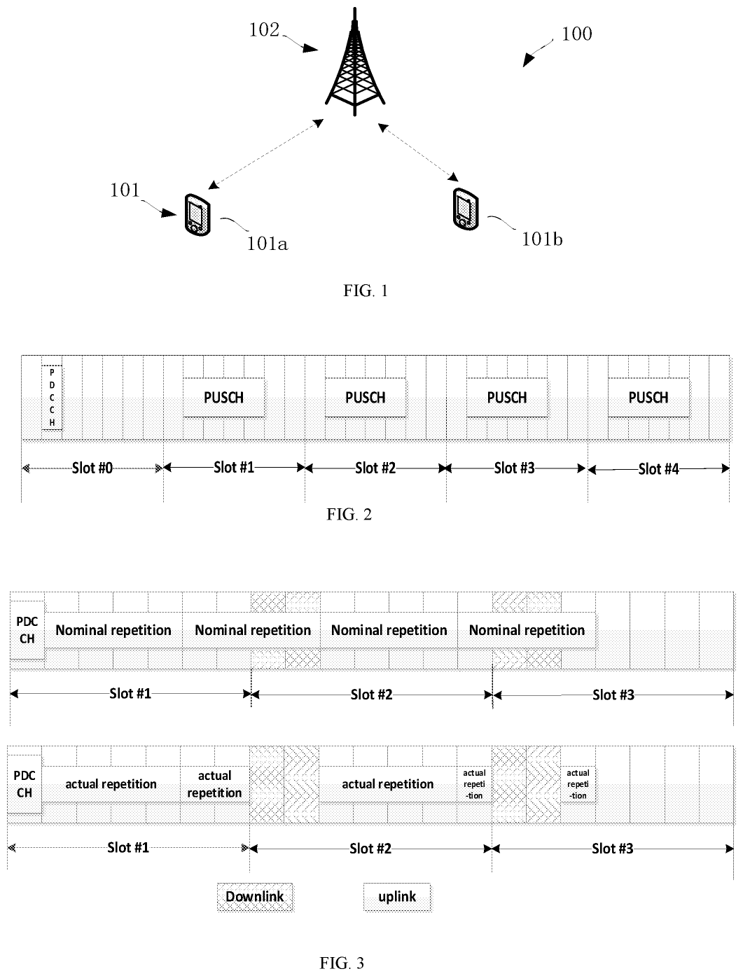

FIG. 1 illustrates a schematic diagram of a wireless communication system 100 according to some embodiments of the present disclosure. As shown in FIG. 1, wireless communication system 100 may include some UEs 101 (e.g., UE 101a and UE 101b) and a base station (e.g., BS 102). Although a specific number of UEs 101 and BS 102 are depicted in FIG. 1, it is contemplated that any number of UEs and BSs may be included in the wireless communication system 100.

UE(s) 101 may include computing devices, such as desktop computers, laptop computers, personal digital assistants (PDAs), tablet computers, smart televisions (e.g., televisions connected to the Internet), set-top boxes, game consoles, security systems (including security cameras), vehicle on-board computers, network devices (e.g., routers, switches, and modems), or the like. According to some embodiments of the present disclosure, UE(s) 101 may include a portable wireless communication device, a smart phone, a cellular telephone, a flip phone, a device having a subscriber identity module, a personal computer, a selective call receiver, or any other device that is capable of sending and receiving communication signals on a wireless network. In some embodiments of the present disclosure, UE(s) 101 includes wearable devices, such as smart watches, fitness bands, optical head-mounted displays, or the like. Moreover, UE(s) 101 may be referred to as a subscriber unit, a mobile, a mobile station, a user, a terminal, a mobile terminal, a wireless terminal, a fixed terminal, a subscriber station, a user terminal, or a device, or described using other terminology used in the art. UE(s) 101 may communicate with BS 102 via uplink (UL) communication signals.

BS 102 may be distributed over a geographic region. In certain embodiments of the present disclosure, BS 102 may also be referred to as an access point, an access terminal, a base, a base unit, a macro cell, a Node-B, an evolved Node B (eNB), a gNB, a Home Node-B, a relay node, or a device, or described using other terminology used in the art. BS 102 is generally a part of a radio access network that may include one or more controllers communicably coupled to one or more corresponding BSs 102. BS 102 may communicate with UE(s) 101 via downlink (DL) communication signals.

The wireless communication system 100 may be compatible with any type of network that is capable of sending and receiving wireless communication signals. For example, the wireless communication system 100 is compatible with a wireless communication network, a cellular telephone network, a time division multiple access (TDMA)-based network, a code division multiple access (CDMA)-based network, an orthogonal frequency division multiple access (OFDMA)-based network, an LTE network, a 3GPP-based network, a 3GPP 5G network, a satellite communications network, a high altitude platform network, and/or other communications networks.

In some embodiments of the present disclosure, the wireless communication system 100 is compatible with 5G NR of the 3GPP protocol. For example, BS 102 may transmit data using an orthogonal frequency division multiple (OFDM) modulation scheme on the DL and UE(s) 101 may transmit data on the UL using a discrete Fourier transform-spread-orthogonal frequency division multiplexing (DFT-S-OFDM) or cyclic prefix-OFDM (CP-OFDM) scheme. More generally, however, the wireless communication system 100 may implement some other open or proprietary communication protocols, for example, WiMAX, among other protocols.

In some embodiments of the present disclosure, BS 102 and UE(s) 101 may communicate using other communication protocols, such as the IEEE 802.11 family of wireless communication protocols. Further, in some embodiments of the present disclosure, BS 102 and UE(s) 101 may communicate over licensed spectrums, whereas in some other embodiments, BS 102 and UE(s) 101 may communicate over unlicensed spectrums. The present disclosure is not intended to be limited to the implementation of any particular wireless communication system architecture or protocol.

Currently, a UE may transmit data signals to a BS (e.g., a gNB) via a PUSCH. A PUSCH transmission(s) may be dynamically scheduled by a UL grant in a DCI, or may be transmitted based on a configured grant (CG) such as CG Type 1 or CG type 2 as specified in 3GPP standard documents. The CG Type 1 based PUSCH transmission may refer to that: a PUSCH transmission is semi-statically configured to operate in response to the reception of a higher layer parameter (e.g., the parameter configuredGrantConfig including rre-ConfiguredUplinkGrant as specified in 3GPP standard documents) without the detection of a UL grant in a DCI. The CG Type 2 based PUSCH transmission may refer to that: a PUSCH transmission is semi-persistently scheduled by a UL grant in a valid activation DCI after the reception of a higher layer parameter (e.g., the parameter configuredGrantConfig not including rrc-ConfiguredUplinkGrant as specified in 3GPP standard documents).

Various waveforms, including for example, DFT-s-OFDM waveform and CP-OFDM waveform, are supported in a PUSCH transmission(s) and may have their respective advantages in different scenarios. For example, for a PUSCH transmission with a DFT-s-OFDM waveform, only one layer is supported while for a PUSCH transmission with a CP-OFDM waveform, up to four layers can be supported. Moreover, compared with the CP-OFDM waveform, the peak to average power ratio (PAPR) of the DFT-s-OFDM waveform is relatively lower, but the efficiency of a UE's power amplifier is higher. Given this, different waveforms may be used in different scenarios. For example, if a UE is at a cell center or near the cell center, it would be advantageous to transmit a PUSCH with a CP-OFDM waveform for a higher throughput. In another example, if a UE is at a cell edge or near a cell edge, it would be advantageous to transmit a PUSCH a DFT-s-OFDM waveform since it can provide better coverage due to higher power efficiency.

In 3GPP NR previous releases, waveforms used by the PUSCH could be indicated by RRC parameter(s). In 3GPP Rel-18, it is agreed to study a dynamic switching of a UL waveform to facilitate the advantage of multi-layer PUSCH transmission and a UE's power efficiency for enhanced coverage. The potential switching method may be by a MAC-CE message or by a DCI indication.

In some embodiments of the present disclosure, the waveform applied to a PUSCH transmission may be indicated by whether a transform precoding is enabled. For example, if the transform precoding is enabled, a DFT-s-OFDM waveform may be applied; and if the transform precoding is disabled, a CP-OFDM may be applied.

In some embodiments of the present disclosure, a BS may semi-statically configure a waveform for a PUSCH transmission by higher layer (e.g., a layer higher than a physical layer) signaling (e.g., radio resource control (RRC) signaling). Switching between different waveforms by higher layer signaling is relatively slow.

In general, for different transform waveforms, there are many different transmission parameters in DCI. Such as:

### (1) Frequency Domain Resource Assignment:

This field indicates the frequency domain resource for a PUSCH transmission. There are three resource allocation types specified in 3GPP TS 38.214. For PUSCH transmission with DFT-s-OFDM, only resource allocation type 1 and resource allocation type 2 are supported, while for PUSCH transmission with CP-OFDM all the three kinds of resource allocation are supported. For PUSCH transmission with different waveform, different resource allocation type may be configured.

### (2) Frequency Hopping Flag:

This field is used for indicating whether the scheduled PUSCH transmission is frequency hopping or not. PUSCH transmission with resource allocation type 1 can support frequency hopping.

### (3) SRS Resource Indicator:

This field is used to indicate the SRS resource(s) for the scheduled or activated PUSCH transmission and to indicate the number of layers of the PUSCH transmission for a non-codebook based PUSCH transmission. For non-codebook based PUSCH transmission, the bit width is

$$⌈ {log}_{2} ( {\sum }_{k = 1}^{min \{ {L}_{max} , {N}_{S R S} \}} ( \begin{matrix}{N}_{S R S} \\ k\end{matrix} ) ) ⌉ ,$$

the Lₘₐₓ is the maximum transmission layer supported by CP-OFDM for dynamic switching between CP-OFDM and DFT-s-OFDM and NSRS is the number of SRS resource in the SRS resource set for non-codebook based transmission. Since PUSCH transmission with DFT-s-OFDM can support only one layer,

$$⌈ {log}_{2} ( {\sum }_{k = 1}^{min ( 1 , {N}_{S R S} )} ( \begin{matrix}{N}_{S R S} \\ k\end{matrix} ) ) ⌉ LSB$$

used for indicating SRS resource(s) for PUSCH transmission with DFT-s-OFDM.

### (4) Second SRS Resource Indicator:

This field is also used to indicate the SRS resource(s) which is introduced in Rel-17 to support a PUSCH repetition transmission to M-TRP. For non-codebook based PUSCH transmission, the bit width is

$$⌈ {log}_{2} ( {max}_{k ∈ \{ 1 , 2 , … , min \{ {L}_{max} , {N}_{S R S} \} \}} ( \begin{matrix}{N}_{S R S} \\ k\end{matrix} ) ) ⌉$$

with the same number of layers indicated by SRS resource indicator field. Same as SRS resource indicator, since PUSCH transmission with DFT-s-OFDM can support only one layer,

$$⌈ {log}_{2} ( {max}_{k ∈ \{ 1 , 2 , … , min \{ 1 , {N}_{S R S} \} \}} ( \begin{matrix}{N}_{S R S} \\ k\end{matrix} ) ) ⌉ LSB$$

used for indicating SRS resource(s) for PUSCH transmission with DFT-s-OFDM.

### (5) Precoding Information and Number of Layers:

This field is used to indicate the transmission layer for a codebook based PUSCH transmission and to indicate the precoder matrix for the PUSCH transmission. The bit width of this field is determined based on txConfig (which configure either codebook or non-codebook based PUSCH for the active BWP), the waveform, full power transmission mode, the number of antenna ports and maximum transmission layers of PUSCH transmission. For different transmission waveforms, maximum number of transmission layers is different

### (6) Antenna Ports:

This field is used to indicate the DMRS port of the scheduled or activated PUSCH transmission. The bit width of this field is determined based on DMRS configuration, waveform, and/or rank of PUSCH transmission. For different waveforms, different DMRS may be configured and different rank of PUSCH transmission is supported.

### (7) Ptrs-Dmrs Association:

This field is used to indicate the association between a PTRS port and a DMRS port for the scheduled or activated PUSCH transmission. For PUSCH transmission with DFT-s-OFDM, since the maximum layer of PUSCH transmission is one, this field is 0 bit. But for PUSCH transmission with CP-OFDM and maximum layer of PUSCH transmission is more than one, 2 bits are used for indicating the association between PTRS and DMRS port. To support dynamic between DFT-s-OFDM and CP-OFDM, if the configured maximum layer of PUSCH transmission is more than one, 2 bits of this field shall be reserved.
If the indicated waveform is DFT-s-OFDM, the UE shall ignore this field.
If second PT-RS association field is present in the scheduling DCI, it is only applied for PUSCH transmission with CP-OFDM. For PUSCH transmission with DFT-s-OFDM, UE will ignore this field.

### (8) Beta_Offset Indicator:

The field is for indicating beta-offset used for calculating the number of resource element when multiplex UCI on a PUSCH transmission. Generally, the total resources of a PUSCH transmission with CP-OFDM is more than a PUSCH transmission with DFT-s-OFDM since CP-OFDM can support more PUSCH transmission layers. Then, different beta_offset may be configured for CP-OFDM and DFT-s-OFDM, for example, for PUSCH transmission with CP-OFDM, beta_offset may be configured as dynamic, but for PUSCH transmission with DFT-s-OFDM, beta_offset may be configured as semiStatic.

### (9) DMRS Sequence Initialization:

This field is 1 bit to indicate one of the two DMRS scrambling IDs for CP-OFDM only. To support dynamic between DFT-s-OFDM and CP-OFDM, this field is 1 bit, and if the indicated waveform is DFT-s-OFDM, UE shall ignore this field.

Regarding a PUSCH transmission scheme, there are four main schemes for resource allocation in time domain of dynamically scheduled PUSCH, which include: PUSCH repetition Type A introduced in 3GPP Rel-15; PUSCH repetition Type B introduced in 3GPP Rel-16; enhanced PUSCH repetition Type A (which is beneficial for PUSCH coverage enhancements for TDD) recommended to be supported in 3GPP Rel-17; and a transmission block processing over multiple slots (TBoMS) (which is beneficial for PUSCH coverage enhancements) recommended to be supported in 3GPP Rel-17. For a certain PUSCH transmission, which scheme among these four schemes is used could be configured by higher layer parameter. Time domain resource allocation for these four schemes could be found in the following.

### (1) PUSCH Repetition Type A

In particular, for PUSCH repetition Type A, the starting symbol S relative to the start of the slot, and the number of consecutive symbols L counting from the symbol S allocated for the PUSCH are determined from the start and length indicator SLIV of the indexed row:

```
  if (L − 1) ≤ 7 then
    SLIV = 14 · (L − 1) + S
  else
    SLIV = 14 · (14 − L + 1) + (14 − 1 − S)
where 0 < L ≤ 14 − S .
```

When transmitting PUSCH scheduled by DCI format 0_1 or 0_2 in PDCCH with cyclic redundancy check (CRC) scrambled with C-RNTI, MCS-C-RNTI, or CS-RNTI with NDI=1, the number of repetitions K is determined as:
if numberOfRepetitions is present in the resource allocation table, the number of repetitions K is equal to numberOfRepetitions;
else if the UE is configured with pusch-AggregationFactor, the number of repetitions K is equal to pusch-AggregationFactor;
otherwise K=1.

For PUSCH repetition Type A, in case K>1, the same symbol allocation is applied across the K consecutive slots. The UE shall repeat the transmission block (TB) across the K consecutive slots applying the same symbol allocation in each slot.

FIG. 2 illustrates an example for a PUSCH transmission with PUSCH repetition Type A according to some embodiments of the present disclosure. The embodiments of FIG. 2 assume that K₂=1, S=2, L=8, K=4. The time domain resources for a PUSCH transmission with PUSCH repetition Type A are shown in FIG. 2. Each of five slots in FIG. 2, i.e., Slot #0 to Slot #4, includes 14 symbols. As shown in FIG. 2, each slot is divided into seven parts, and each part includes two symbols for illustrative purpose. In the embodiments of FIG. 2, a PDCCH transmission is transmitted in Slot #0. Since S=2, each PUSCH transmission is transmitted from a start of the third symbol in a slot. Since K₂=1, the first PUSCH transmission in time domain is transmitted in Slot #1. Since K=4, there are four PUSCH transmissions transmitted in Slot #1, Slot #2, Slot #3, and Slot #4, respectively. Since L=8, each PUSCH transmission transmitted in Slot #1, Slot #2, Slot #3, and Slot #4 include 8 symbols.

For PUSCH repetition Type A, a PUSCH transmission in a slot of a multi-slot PUSCH transmission is omitted if any symbol of the PUSCH is overlapped with the set of symbols of the slot that are indicated to a UE as a DL by tdd-UL-DL-ConfigurationCommon, or tdd-UL-DL-ConfigurationDedicated.

### (2) PUSCH Repetition Type B

In particular, for PUSCH repetition Type B, the number of nominal repetitions is given by numberOfRepetitions. For the n-th nominal repetition, n=0, . . . , numberOfRepetitions−1,
The slot where the nominal repetition starts is given by

$${K}_{s} + ⌊ \frac{S + n \cdot L}{{N}_{s y m b}^{slot}} ⌋ ,$$

and the starting symbol relative to the start of the slot is given by

$$mod ( S + n \cdot L , {N}_{symb}^{slot} ) .$$

The slot where the nominal repetition ends is given by

$${K}_{s} + ⌊ \frac{S + ( n + 1 ) \cdot L - 1}{{N}_{symb}^{s l o t}} ⌋ ,$$

and the ending symbol relative to the start of the slot is given by

$$mod ( S + ( n + 1 ) \cdot L - 1 , {N}_{symb}^{slot} ) .$$

Here Kₛ is the slot where the PUSCH transmission starts, and

$${N}_{symb}^{s l o t}$$

is the number of symbols per slot. The starting symbol S relative to the start of the slot, and the number of consecutive symbols L counting from the symbol S allocated for the PUSCH are provided by startSymbol and length of the indexed row of the resource allocation table, respectively.

For PUSCH repetition Type B, a symbol that is indicated as a DL by tdd-UL-DL-ConfigurationCommon, or tdd-UL-DL-ConfigurationDedicated, is considered as an invalid symbol for PUSCH repetition Type B transmission. After determining the invalid symbol(s) for PUSCH repetition Type B transmission for each of the K nominal repetitions, the remaining symbols are considered as potentially valid symbols for PUSCH repetition Type B transmission. If the number of potentially valid symbols for PUSCH repetition Type B transmission is greater than zero for a nominal repetition, the nominal repetition consists of one or more actual repetitions, where each actual repetition consists of a consecutive set of all potentially valid symbols that can be used for PUSCH repetition Type B transmission within a slot. An actual repetition with a single symbol is omitted except for the case of/=1.

An actual repetition is omitted if any symbol of the PUSCH is overlapped with the set of symbols of the slot that are indicated to a UE as a DL by tdd-UL-DL-ConfigurationCommon, or tdd-UL-DL-ConfigurationDedicated.

FIG. 3 illustrates an example for a PUSCH transmission with PUSCH repetition Type B according to some embodiments of the present disclosure. The embodiments of FIG. 3 assume that K₂=0, S=2, L=8, K=4, and then, the time domain resource for a PUSCH transmission with PUSCH repetition Type B could be seen in FIG. 3. Each of three slots in FIG. 3, i.e., Slot #1, Slot #2, or Slot #3, includes 14 symbols. As shown in FIG. 3, each slot is divided into seven parts, and each part includes two symbols for illustrative purpose. In the embodiments of FIG. 3, a PDCCH transmission is transmitted in Slot #1. Since K₂=0, the first nominal repetition of the PUSCH transmission in time domain is transmitted in Slot #1. Since S=2, the first nominal repetition is transmitted from a start of the third symbol in Slot #1. Since K=4, there are four nominal repetitions transmitted in Slot #1, Slot #2, and Slot #3, respectively. Since L=8, each nominal repetition PUSCH transmission includes 8 symbols, and all four nominal repetitions are consequent. As shown in FIG. 3, since the first to fourth symbols in Slot #2 and the first to fourth symbols in Slot #3 are configured with a DL transmission direction, so the symbols in the first to fourth symbols in Slot #2 and the first to fourth symbols in Slot #3 are invalid symbols. That is, five actual repetitions in symbols in Slot #1, Slot #2, and Slot #3 are determined for transmission.

### (3) Enhanced PUSCH Repetition Type A

In particular, for enhanced PUSCH repetition Type A, the resource allocation in time domain for enhanced PUSCH repetition Type A is almost the same as PUSCH repetition Type A, excluding that the number of repetitions is counted on the basis of available slots. A slot is determined as unavailable if at least one of the symbols indicated by a time domain resource allocation (TDRA) for a PUSCH in the slot overlaps with the symbol not intended for UL transmissions, and semi-static flexible symbol configured by tdd-UL-DL-ConfigurationCommon, or tdd-UL-DL-ConfigurationDedicated, is considered as available.

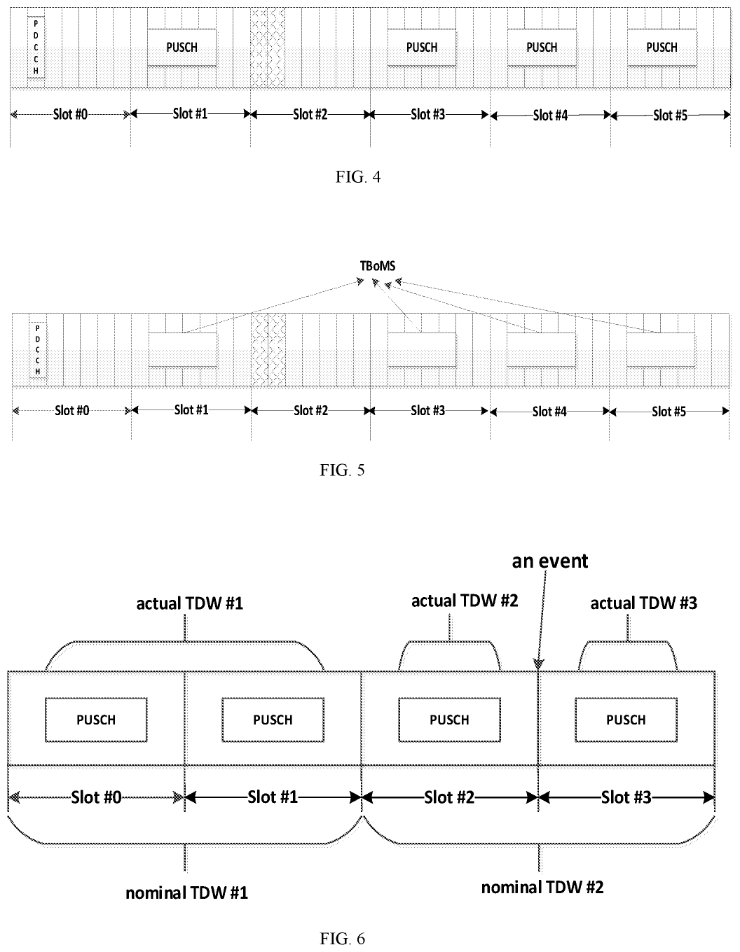

FIG. 4 illustrates an example for a PUSCH transmission with enhanced PUSCH repetition Type A according to some embodiments of the present disclosure. The embodiments of FIG. 4 assume that K₂=1, S=2, L=8, K=4. Then, the time domain resources for PUSCH with enhanced PUSCH repetition Type A are shown in FIG. 4. Each of six slots in FIG. 2, i.e., Slot #0 to Slot #5, includes 14 symbols. As shown in FIG. 4, each slot is divided into seven parts, and each part includes two symbols for illustrative purpose. In the embodiments of FIG. 4, a PDCCH transmission is transmitted in Slot #0. Since S=2, each PUSCH transmission is transmitted from a start of the third symbol in a slot. Since K₂=1, the first PUSCH transmission in time domain is transmitted in Slot #1. Since K=4 and since the first to fourth symbols in Slot #2 are configured with a DL transmission direction, four PUSCH transmissions are transmitted in Slot #1, Slot #3, Slot #4, and Slot #5, respectively. That is, no PUSCH transmission is transmitted in Slot #2. Since L=8, each PUSCH transmission transmitted in Slot #1, Slot #3, Slot #4, and Slot #5 include 8 symbols.

### (4) TBoMS

In particular, for a TBoMS, the time domain resource determination can be performed via PUSCH repetition Type A, like TDRA. The number of slots K allocated for TBoMS is determined by using a row index of a TDRA list, configured via RRC and is counted based on the available slots for UL transmission. The transmission in each slot could be named as one transmission part of the TB in some cases. The determination of available slots is the same as defined in enhanced PUSCH repetition Type A.

FIG. 5 illustrates an example for a PUSCH transmission with TBoMS according to some embodiments of the present disclosure. The embodiments of FIG. 5 assume that K₂=1, S=2, L=8, K=4. Then, the time domain resource for PUSCH with TBoMS could be seen in FIG. 5. Each of six slots, i.e., Slot #0 to Slot #6, in FIG. 5 includes 14 symbols. As shown in FIG. 5, each slot is divided into seven parts, and each part includes two symbols for illustrative purpose. In the embodiments of FIG. 5, a PDCCH transmission is transmitted in Slot #0. Since S=2, each part of one PUSCH transmission is transmitted from a start of the third symbol in a slot. Since K₂=1, the first part of the PUSCH transmission in time domain is transmitted in Slot #1. Since K=4 and since the first to fourth symbols in Slot #2 are configured with a DL transmission direction, four parts of the PUSCH transmissions are transmitted in Slot #1, Slot #3, Slot #4, and Slot #5, respectively. That is, no part of the PUSCH transmission is transmitted in Slot #2. Since L=8, each part of the PUSCH transmission transmitted in Slot #1, Slot #3, Slot #4, and Slot #5 include 8 symbols.

Regarding a resource allocation in time domain, for CG Type 1 PUSCH transmissions, the higher layer parameter timeDomainAllocation value m provides a row index m+1 pointing to the determined time domain resource allocation table, where the start symbol and length are determined following the procedure defined in above for dynamically scheduled PUSCH. Regarding a resource allocation in time domain, for CG Type 2 PUSCH transmissions, the resource allocation follows UL grant received on the DCI.

There are also four main resource allocation schemes in time domain for CG Type 1 PUSCH transmissions or CG Type 2 PUSCH transmission(s), which include: (1) PUSCH repetition Type A; (2) PUSCH repetition Type B; (3) enhanced PUSCH repetition Type A; and (4) TBoMS. These four schemes have some differences from the resource allocation schemes in time domain for dynamically scheduled PUSCH transmission(s) as described above. For example, in resource allocation schemes in time domain for CG Type 1 or Type 2 PUSCH transmissions, for PUSCH repetition Type A, PUSCH repetition Type B, an enhanced PUSCH repetition Type A, and TBoMS, the number of (nominal) repetitions K to be applied to the transmitted transport block is provided by the indexed row in the time domain resource allocation table if numberOfRepetitions is present in the table; otherwise, K is provided by the higher layer configured parameters repK. Besides, other procedures defined in the resource allocation schemes in time domain for dynamically scheduled PUSCH transmission(s) as described above could be reused in the resource allocation schemes in time domain for CG Type 1 or Type 2 PUSCH transmission(s).

In particular, for PUSCH repetition Type B, for CG Type 1 or Type 2 PUSCH transmission(s), nominal repetition(s) and actual repetition(s) are determined according to the procedures for PUSCH repetition Type B defined in the resource allocation schemes in time domain for dynamically scheduled PUSCH transmission(s).

Currently, a UE may perform a procedure to determine time domain windows (TDW) s for bundling DMRS. For PUSCH transmissions of PUSCH repetition Type A scheduled by DCI format 0_1 or 0_2, PUSCH repetition Type A with a CG, PUSCH repetition Type B, and/or TBoMS, when PUSCH-DMRS-Bundling is enabled, the UE may determine one or more nominal TDWs, as follows:
For PUSCH transmissions of repetition Type A, PUSCH repetition Type B, and TBoMS, the duration of each nominal TDW except the last nominal TDW, in number of consecutive slots, is:
   Given by PUSCH-TimeDomainWindowLength, if configured.
   Computed as min ([maxDMRS-BundlingDuration], M), if PUSCH-Time Domain Window Length is not configured, where M is the time duration in consecutive slots of N·K PUSCH transmissions, and where:
      For PUSCH transmissions of PUSCH repetition Type A, N=1 and K is the number of repetitions, as defined in Clause 6.1.2.1.
      For PUSCH transmissions of PUSCH repetition Type B, N=1 and K is the number of nominal repetitions, as defined in Clause 6.1.2.1.
      For PUSCH transmissions of TBoMS, N is the number of slots used for TBS determination and K is the number of repetitions of the number of slots N used for TBS determination, as defined in Clause 6.1.2.1.
For PUSCH transmission of a PUSCH repetition Type A scheduled by DCI format 0_1 or 0_2 and PUSCH repetition Type A with a CG, when Available SlotCounting is enabled, and for TBoMS:
   The start of the first nominal TDW is the first slot determined for the first PUSCH transmission.
   The end of the last nominal TDW is the last slot determined for the last PUSCH transmission.
   The start of any other nominal TDWs is the first slot determined for PUSCH transmission after the last slot determined for PUSCH transmission of a previous nominal TDW.
For PUSCH transmissions of a PUSCH repetition Type A scheduled by DCI format 0_1 or 0_2 and PUSCH repetition Type A with a CG, when the UE is not configured with AvailableSlotCounting or when AvailableSlotCounting is disabled, and for PUSCH repetition Type B:
   The start of the first nominal TDW is the first slot for the first PUSCH transmission.
   The end of the last nominal TDW is the last slot for the last PUSCH transmission.
   The start of any other nominal TDWs is the first slot after the last slot of a previous nominal TDW.

For PUSCH transmissions of PUSCH repetition Type A scheduled by DCI format 0_1 or 0_2, PUSCH repetition Type A with a CG, PUSCH repetition Type B and TBoMS, a nominal TDW consists of one or more actual TDWs. The UE may determine the actual TDWs as follows:
The start of the first actual TDW is the first symbol of the first PUSCH transmission in a slot for PUSCH transmission of PUSCH repetition Type A scheduled by DCI format 0_1 or 0_2, or PUSCH repetition Type A with a CG, or PUSCH repetition Type B or TBoMS within the nominal TDW.
The end of an actual TDW may be one of followings:
   The last symbol of the last PUSCH transmission in a slot for PUSCH transmission of PUSCH repetition Type A scheduled by DCI format 0_1 or 0_2, or PUSCH repetition Type A with a CG, or PUSCH repetition Type B or TBoMS within the nominal TDW, if the actual TDW reaches the end of the last PUSCH transmission within the nominal TDW.
   The last symbol of a PUSCH transmission before “an event”, if the event occurs which causes power consistency and phase continuity not to be maintained across PUSCH transmissions of PUSCH repetition Type A scheduled by DCI format 0_1 or 0_2, or PUSCH repetition Type A with a CG, or PUSCH repetition Type B or TBoMS within the nominal TDW, and the PUSCH transmission is in a slot for PUSCH transmission of PUSCH repetition Type A scheduled by DCI format 0_1 or 0_2, or PUSCH repetition Type A with a CG, or PUSCH repetition Type B or TBoMS.
   When PUSCH-Window-Restart is enabled, the start of a new actual TDW is the first symbol of the PUSCH transmission after the event which causes power consistency and phase continuity not to be maintained across PUSCH transmissions of PUSCH repetition Type A scheduled by DCI format 0_1 or 0_2, or PUSCH repetition Type A with a CG, or PUSCH repetition Type B or TBoMS within the nominal TDW, and the PUSCH transmission is in a slot for PUSCH transmission of PUSCH repetition Type A scheduled by DCI format 0_1 or 0_2, or PUSCH repetition Type A with a CG, or PUSCH repetition Type B or TBoMS.

In particular, “an event” (which causes power consistency and phase continuity not to be maintained across PUSCH transmissions of PUSCH repetition Type A scheduled by DCI format 0_1 or 0_2, or PUSCH repetition Type A with a CG, or PUSCH repetition Type B or TBoMS) within a nominal TDW may be at least one of followings:
A downlink slot or downlink reception or downlink monitoring based on tdd-UL-DL-ConfigurationCommon and tdd-UL-DL-ConfigurationDedicated for unpaired spectrum.
The gap between any two consecutive PUSCH transmissions, or the gap between any two consecutive PUCCH transmissions, exceeds 13 symbols.
The gap between any two consecutive PUSCH transmissions, or the gap between any two consecutive PUCCH transmissions, does not exceed 13 symbols but other uplink transmissions are scheduled between the two consecutive PUSCH transmissions or the two consecutive PUCCH transmissions.
For PUSCH transmissions of PUSCH repetition Type A, or PUSCH repetition Type B or TBoMS, a dropping or cancellation of a PUSCH transmission according to clause 9, clause 11.1 and clause 11.2A of [6, TS 38.213].
For PUCCH transmissions of PUCCH repetition, a dropping or cancellation of a PUCCH transmission according to clause 9.2.6 and clause 11.1 of [6, TS 38.213].
For any two consecutive PUSCH transmissions of PUSCH repetition Type A, or PUSCH repetition Type B, and when two SRS resource sets are configured in srs-ResourceSetToAddModList or srs-ResourceSetToAddModListDCI-O-2 with higher layer parameter usage in SRS-ResourceSet set to ‘codebook’ or ‘noncodebook’, a different SRS resource set association is used for the two PUSCH transmissions of PUSCH repetition Type A, or PUSCH repetition Type B, according to Clause 6.1.2.1.
For any two consecutive PUCCH transmissions of PUCCH repetition, and when a PUCCH resource used for repetitions of a PUCCH transmission by a UE includes first and second spatial relations, different spatial relations are used for the two PUCCH transmissions of PUCCH repetition, according to Clause 9.2.6 of [6, TS 38.213].
Uplink timing adjustment in response to a timing advance command according to clause 4.2 of [6, TS 38.213].
Frequency hopping.

In case that an actual TDW is created in response to frequency hopping or in response to “an event” not triggered by DCI or MAC-CE, the UE shall maintain power consistency and phase continuity within the actual TDW, across PUSCH transmissions of PUSCH repetition Type A scheduled by DCI format 0_1 or 0_2, or PUSCH repetition Type A with a CG, or PUSCH repetition Type B or TBoMS, or across PUCCH transmissions of PUCCH repetitions.

In case that an actual TDW is created in response to “an event” triggered by DCI other than frequency hopping or by MAC-CE, whether the UE maintains power consistency and phase continuity within the actual TDW, across PUSCH transmissions of PUSCH repetition Type A scheduled by DCI format 0_1 or 0_2, or PUSCH repetition Type A with a CG, or PUSCH repetition Type B, or TBoMS, or across PUCCH transmissions of PUCCH repetition, depends upon the UE's capability.

FIG. 6 illustrates an example for a PUSCH transmission with TDW according to some embodiments of the present disclosure. The embodiments of FIG. 6 assume that the duration of each nominal TDW (i.e., nominal TDW #1 or nominal TDW #2) is configured to 2 slots, and assume that PUSCH transmissions are transmitted in 4 slots (i.e., Slot #0 to Slot #3) with PUSCH repetition Type A or PUSCH repetition Type B or TBoMS. According to the methods above, actual TDWs would be determined. In nominal TDW #1, there could be one actual TDW (i.e., actual TDW #1) from the start symbol of the first PUSCH transmission to the end symbol of the second PUSCH transmission. In nominal TDW #2, considering that “an event” as mentioned above occurs, there could be two actual TDWs (i.e., actual TDW #2 and actual TDW #3).

As mentioned before, in 3GPP Rel-18, it is agreed to study a dynamic switching of UL waveform to facilitate the advantage of multi-layer PUSCH transmission and a UE's power efficiency for enhanced coverage. The potential switching method may be by a MAC-CE message or by a DCI indication. There would be some time interval from “a time point of receiving the signaling” to “a time point of the signaling taking effect”. For example, assuming that signaling indicating switching from first transform precoding state to second transform precoding state is received in symbol n and the signaling would take effect in symbol n+k, it means that the transform precoding state of PUSCH transmission(s) after or from the symbol n+k should be switched from first transform precoding state to second transform precoding state, or the switching is applied to PUSCH transmission(s) after or from the symbol n+k. “The signaling takes effect from one PUSCH transmission” means that the switching is applied to one or more PUSCH transmission(s) from the one PUSCH transmission, and the transform precoding state of PUSCH transmission(s) after or from the one PUSCH transmission should be switched from first transform precoding state to second transform precoding state. Or, “the signaling takes effect from one PUSCH transmission” means that the signaling takes effect for one or more PUSCH transmission from the one PUSCH transmission. Then, there would be a case that the signaling indicating switching of transform precoding states takes effect between PUSCH transmissions among one or multiple slots, the PUSCH transmissions could be PUSCH transmissions of PUSCH repetitions (including repetition Type A or Type B) or TBoMS. Considering that transmission parameter(s) for different transform precoding states should be different and considering the complexity of a network node for receiving the PUSCH transmissions, issues of how a UE transmits remaining PUSCH transmission(s) and how a UE determines TDW(s) for bundling DMRS should be addressed.

Embodiments of the present disclosure aim to solve the above-mentioned issues. For example, some embodiments of the present disclosure propose solutions in which a UE receives signaling indicating switching of transform precoding states, which would take effect for one or more PUSCH transmissions of a PUSCH repetition or a TBoMS. The UE may determine whether the signaling takes effect or not for the one or more PUSCH transmissions. The UE may transmit the PUSCH transmissions according to the determination. Some embodiments of the present disclosure propose solutions in which a UE determines TDW(s) for bundling DMRS by taking “the switching between transform precoding states for any two consecutive PUSCH transmissions” as “an event” which causes power consistency and phase continuity not to be maintained across PUSCH transmissions of PUSCH repetition or TBoMS.

For example, some embodiments of the present disclosure propose solutions in which a UE receives signaling indicating switching of transform precoding states, which would take effect for one PUSCH transmission of a PUSCH repetition or a TBoMS. The UE may determine whether the signaling takes effect or not from the one PUSCH transmission. The UE may transmit one or more PUSCH transmissions of the PUSCH repetition or the TBoMS according to the determination. Some embodiments of the present disclosure propose solutions in which a UE determines TDW(s) for bundling DMRS by taking “the switching between transform precoding states for any two consecutive PUSCH transmissions” as “an event” which causes power consistency and phase continuity not to be maintained across PUSCH transmissions of a PUSCH repetition or a TBoMS.

More details on the embodiments of the present disclosure will be illustrated in the following text in combination with the appended drawings.

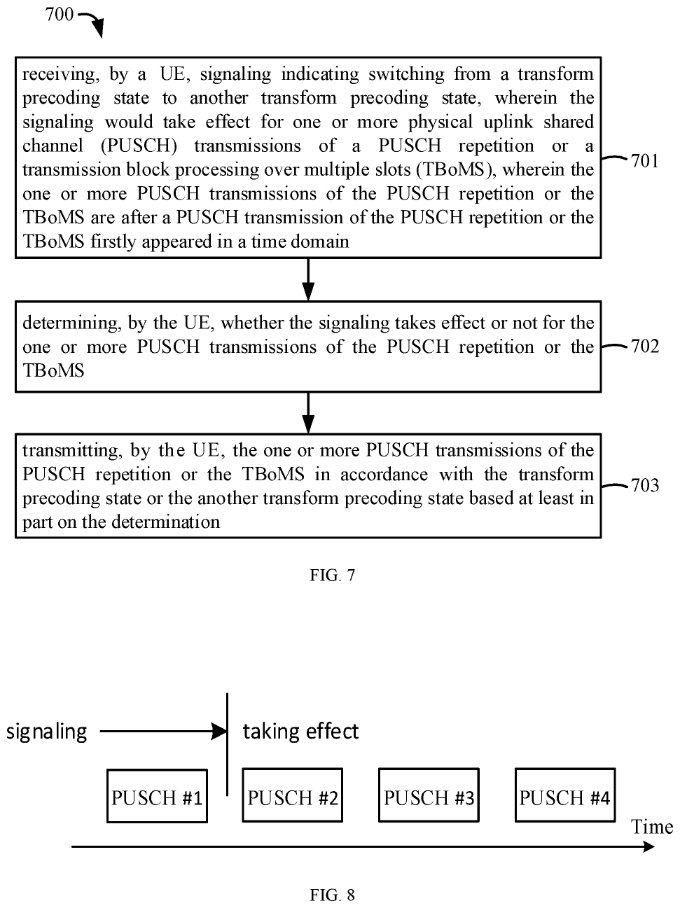

FIG. 7 illustrates a flowchart of an exemplary procedure for switching transform precoding states according to some embodiments of the present disclosure. The method in FIG. 7 may be implemented by a UE (e.g., UE 101 in FIG. 1). Details described in all other embodiments of the present disclosure are applicable for the embodiments shown in FIG. 7.

In the exemplary procedure 700 shown in FIG. 7, in operation 701, a UE (e.g., UE 101a in FIG. 1) may receive “signaling indicating switching from a transform precoding state (denoted as transform precoding state #1 for simplicity) to another transform precoding state (denoted as transform precoding state #2 for simplicity)”, e.g., from a network node (e.g., BS 102 in FIG. 1).

In some embodiments, transform precoding state #1 is an enabled state, and transform precoding state #2 is a disabled state. In some other embodiments, transform precoding state #1 is a disabled state, and transform precoding state #2 is an enabled state. For instance, if a transform precoding state for a PUSCH transmission is an enabled state, DFT-s-OFDM would be used. If a transform precoding state for a PUSCH transmission is a disabled state, CP-OFDM would be used.

The signaling received in operation 701 would take effect for one or more PUSCH transmission (e.g., PUSCH #2, PUSCH #3, and/or PUSCH #4 in FIG. 8) of a PUSCH repetition or a TBoMS, or in other words, the signaling received in operation 701 would take effect from one PUSCH transmission (e.g., PUSCH #2 in FIG. 8). The one or more PUSCH transmissions or the one PUSCH transmission are after a PUSCH transmission of the PUSCH repetition or the TBoMS firstly appeared in a time domain (e.g., PUSCH #1 in FIG. 8), which may be named as “the first PUSCH transmission of the PUSCH repetition or the TBoMS”. In some embodiments, a PUSCH transmission of the one or more PUSCH transmissions of the PUSCH repetition, or the one PUSCH transmission of the PUSCH repetition may be:
(1) a PUSCH transmission of PUSCH repetition Type A scheduled by a DCI format, e.g., DCI format 0_1 or 0_2; or
(2) a PUSCH transmission of PUSCH repetition Type A with a CG, e.g., CG Type 1 or CG Type 2; or
(3) a PUSCH transmission of PUSCH repetition Type B.

In some embodiments, the signaling may take effect after “the first PUSCH transmission of the PUSCH repetitions or the TBoMS” but before “the last PUSCH transmission of the PUSCH repetitions or the TBoMS”. For example, for any two consecutive PUSCH transmissions of PUSCH repetition Type A or PUSCH repetition Type B, different transform precoding states would be used according to the signaling for these two consecutive PUSCH transmissions of PUSCH repetition Type A or PUSCH repetition Type B.

In operation 702, the UE may determine whether the signaling takes effect or not for the one or more PUSCH transmissions (e.g., PUSCH #2, PUSCH #3, and/or PUSCH #4 in FIG. 8) of the PUSCH repetition or the TBoMS. Or, the UE may determine whether the signaling takes effect or not from the one PUSCH transmission (e.g., PUSCH #2 in FIG. 8). In operation 703, the UE may transmit the one or more PUSCH transmissions (e.g., PUSCH #2, PUSCH #3, and/or PUSCH #4 in FIG. 8) of the PUSCH repetition or the TBoMS in accordance with transform precoding state #1 or transform precoding state #2 based at least in part on the determination in operation 702.

In some embodiments, in response to receiving, e.g., from the network node, two or more messages including the signaling which would take effect for the one or more PUSCH transmissions of the PUSCH repetition or the TBoMS or would take effect from the one PUSCH transmission of the PUSCH repetition or the TBoMS, the UE only determines whether the signaling included in a message lastly received by the UE within the two or more messages takes effect or not. The signaling included in the two or more messages other than the lastly received message would not take effect. For example, if more than one signaling indicating switching of transform precoding states would take effect among PUSCH transmissions of the PUSCH repetition or the TBoMS, only the last signaling could take effect after “the first PUSCH transmission of the PUSCH repetition or the TBoMS”.

In some embodiments, in response to determining that the signaling takes effect for the one or more PUSCH transmissions of the PUSCH repetition or the TBoMS or takes effect from the one PUSCH transmission of the PUSCH repetition or the TBoMS, the UE may switch from transform precoding state #1 to transform precoding state #2 for the one or more PUSCH transmissions. In some embodiments, in response to determining that the signaling does not take effect for the one or more PUSCH transmissions for from the one PUSCH transmission, the UE may transmit the one or more PUSCH transmissions (e.g., PUSCH #2 to PUSCH #4 in FIG. 8) without switching from transform precoding state #1 to transform precoding state #2.

To determine whether the signaling takes effect or not for the one or more PUSCH transmissions of the PUSCH repetition or the TBoMS or takes effect from the one PUSCH transmission of the PUSCH repetition or the TBoMS, the UE may perform different operations in different embodiments as follows.

In particular, in some embodiments of the present disclosure, after receiving the signaling in operation 701, the UE may determine that the signaling does not take effect for the one or more PUSCH transmissions of the PUSCH repetition or the TBoMS, or the UE may determine that the signaling does not take effect from the one PUSCH transmission of the PUSCH repetition or the TBoMS. In an embodiment, in response to determining that the signaling does not take effect, the signaling takes effect after a last PUSCH transmission of the PUSCH repetition or the TBoMS, e.g., the signaling may take effect for a new PUSCH transmission (if any) after the last PUSCH transmission. A specific example is described in the embodiments of FIG. 8.

For instance, in case that the signaling does not take effect for the one or more PUSCH transmissions of the PUSCH repetition or the TBoMS or in case that the signaling does not take effect from the one PUSCH transmission of the PUSCH repetition or the TBoMS:
(1) For PUSCH repetition Type A or PUSCH repetition Type B, the signaling does not take effect on the one or more PUSCH transmissions of all the PUSCH repetitions.
(2) For TBoMS, the signaling does not take effect on the one or more PUSCH transmissions on all the slots.
(3) The signaling takes effect after the end of the one or more PUSCH transmissions. For instance, the end of the one or more PUSCH transmissions could be: the last symbol of a last PUSCH transmission within the PUSCH transmissions; or the last time slot of the PUSCH transmissions.

In some further embodiments of the present disclosure, after receiving the signaling in operation 701, the UE may ignore the signaling. In these embodiments, the UE does not expect to receive the signaling which would take effect for the one or more PUSCH transmissions of the PUSCH repetition or the TBoMS or from the one PUSCH transmission of the PUSCH repetition or the TBoMS, wherein the one or more PUSCH transmissions or the one PUSCH transmission are after the first PUSCH transmission of the PUSCH repetition or the TBoMS. In these embodiments, the UE may consider reception of signaling indicating the switching between transform precoding states as an error case. A network node (e.g., a BS) should not transmit signaling indicating the switching between transform precoding states. Otherwise, the UE would not handle such signaling.

In some other embodiments of the present disclosure, after receiving the signaling in operation 701, the UE may determine that the signaling takes effect for the one or more PUSCH transmissions of the PUSCH repetition or the TBoMS, or the UE may determine that the signaling takes effect from the one PUSCH transmission of the PUSCH repetition or the TBoMS. In some embodiments, the signaling would take effect after the first PUSCH transmission (e.g., PUSCH #1 in FIG. 8) and before the second PUSCH transmission (e.g., PUSCH #2 in FIG. 8) of the PUSCH repetition or the TBoMS, and the signaling takes effect on all the PUSCH transmissions from the second PUSCH transmission (e.g., PUSCH #2, PUSCH #3, and PUSCH #4 in FIG. 8). In other words, the signaling takes effect on the remaining PUSCH transmissions after the time when the signaling would take effect (e.g., between PUSCH #1 and PUSCH #2 in FIG. 8).

In some embodiments, in response to determining that the signaling takes effect for the one or more PUSCH transmissions of the PUSCH repetition or the TBoMS or from the one PUSCH transmission of the PUSCH repetition or the TBoMS, the UE may redetermine transmission parameter(s) for the one or more PUSCH transmissions. In an embodiment, if the signaling takes effect for a certain PUSCH transmission, at least one of following transmission parameters of the certain PUSCH transmission (e.g., PUSCH #2, PUSCH #3, or PUSCH #4 in FIG. 8) should be redetermined according to the transform precoding state indicated by the signaling:
(1) Frequency domain resource assignment type, e.g., resource allocation type 0, resource allocation type 1, and/or resource allocation type 2. For PUSCH transmission with DFT-s-OFDM, only resource allocation type 1 and resource allocation type 2 are supported, while for PUSCH transmission with CP-OFDM all the three kinds of resource allocation are supported.
(2) Frequency hopping flag.
(3) SRS resource indicator.
(4) Second SRS resource indicator.
(5) Precoding information and a number of layers.
(6) Antenna port(s).
(7) PTRS-DMRS association.
(8) Beta offset indicator, e.g., beta_offset indicator.
(9) Value of DMRS sequence initialization.

In other words, in some embodiments, at least one of the above parameters would be different for the one or more PUSCH transmissions and the first PUSCH transmission.

In some embodiments, at least one of the above parameters would be different for the one PUSCH transmission and the first PUSCH transmission.

In some other embodiments, in response to determining that the signaling takes effect for the one or more PUSCH transmissions of the PUSCH repetition or the TBoMS, some transmission parameters for the one or more PUSCH transmissions may be the same as those for a PUSCH transmission of the PUSCH repetition or the TBoMS preceding the one or more PUSCH transmissions. In some other embodiments, in response to determining that the signaling takes effect from the one PUSCH transmission of the PUSCH repetition or the TBoMS, some transmission parameters for the one PUSCH transmission may be the same as those for a PUSCH transmission of the PUSCH repetition or the TBoMS preceding the one PUSCH transmission. In an embodiment, if the signaling takes effect for a certain PUSCH transmission, at least one of following transmission parameters of the certain PUSCH transmission (e.g., PUSCH #2, PUSCH #3, or PUSCH #4 in FIG. 8) may be kept the same as transmission parameters of a PUSCH transmission before the certain PUSCH transmission (e.g., PUSCH #1 in FIG. 8): Frequency domain resource assignment type (e.g., resource allocation type 0, resource allocation type 1, and/or resource allocation type 2); Frequency hopping flag; PTRS-DMRS association; or DMRS sequence initialization; or a MCS value.

Referring back to FIG. 7, in some embodiments of the present disclosure, the UE may determine whether a set of conditions is fulfilled or not before determining whether the signaling takes effect or not in operation 702. In an embodiment, in response to fulfillment of the set of conditions, the UE may determine that the signaling takes effect for the one or more PUSCH transmissions of the PUSCH repetition or the TBoMS, or the UE may determine that the signaling takes effect from the one PUSCH transmission of the PUSCH repetition or the TBoMS. For instance, the set of conditions may include at least one of:
(1) Reception of an indication for indicating that the signaling should take effect. For instance, the UE may receive an indication from the network node by RRC signaling or DCI, which could indicate that the signaling should take effect or not.
(2) A frequency domain resource assignment type of “the first PUSCH transmission of the PUSCH repetition or the TBoMS” (which may be named as “the initial frequency domain resource assignment type”) is not resource allocation type 0. For instance, if the initial frequency domain resource allocation type is resource allocation type 0, the signaling does not take effect; otherwise, the signaling takes effect.
(3) A DMRS scrambling ID for transform precoding state #1 is the same as a DMRS scrambling ID for transform precoding state #2. For instance, if the DMRS scrambling IDs for these two transform precoding states are the same, the signaling takes effect; otherwise, the signaling does not take effect.
(4) A value of DMRS sequence initialization for transform precoding state #1 is the same as a value of DMRS sequence initialization for transform precoding state #2. For instance, if the values of DMRS sequence initialization for these two transform precoding states are the same, the signaling takes effect; otherwise, the signaling does not take effect.
(5) A MCS value for transform precoding state #1 is the same as a MCS value for transform precoding state #2. For instance, if the MCS values for these two transform precoding states are the same, the signaling takes effect; otherwise, the signaling does not take effect.
(6) A frequency hopping flag for transform precoding state #1 is the same as a frequency hopping flag for transform precoding state #2. For instance, if the frequency hopping flags for these two transform precoding states are the same, the signaling takes effect; otherwise, the signaling does not take effect.
(7) A SRS resource indicator for transform precoding state #1 is the same as a SRS resource indicator for transform precoding state #2. For instance, if the SRS resource indicators for these two transform precoding states are the same, the signaling takes effect; otherwise, the signaling does not take effect.
(8) A second SRS resource indicator for transform precoding state #1 is the same as a second SRS resource indicator for transform precoding state #2. For instance, if the second SRS resource indicators for these two transform precoding states are the same, the signaling takes effect; otherwise, the signaling does not take effect.
(9) Precoding information and a number of layers for transform precoding state #1 is the same as precoding information and a number of layers for transform precoding state #2. For instance, if the precoding information and the numbers of layers for these two transform precoding states are the same, the signaling takes effect; otherwise, the signaling does not take effect.
(10) One or more antenna ports for transform precoding state #1 are the same as one or more antenna ports for transform precoding state #2. For instance, if the one or more antenna ports for these two transform precoding states are the same, the signaling takes effect; otherwise, the signaling does not take effect.
(11) A PTRS-DMRS association for transform precoding state #1 is the same as a PTRS-DMRS association for transform precoding state #2. For instance, if the PTRS-DMRS associations for these two transform precoding states are the same, the signaling takes effect; otherwise, the signaling does not take effect.
(12) A beta offset indicator (e.g., beta_offset indicator) for transform precoding state #1 is the same as a beta offset indicator for transform precoding state #2. For instance, if the beta offset indicators for these two transform precoding states are the same, the signaling takes effect; otherwise, the signaling does not take effect.

For example, the UE may determine certain parameter(s) within a set of parameters (e.g., DMRS scrambling IDs, values of DMRS sequence initialization, MCS values, frequency hopping flags, SRS resource indicators, second SRS resource indicators, precoding information and the numbers of layers, one or more antenna ports, PTRS-DMRS associations, and/or beta offset indicators) for transform precoding state #1 and transform precoding state #2 are the same or not, and then determine whether the signaling should take effect based on whether the certain parameter(s) are the same or not. A specific example is described in the embodiments of FIG. 8.

FIG. 8 illustrates an example for determining whether signaling takes effect according to some embodiments of the present disclosure. As shown in FIG. 8, a UE may receive signaling indicating switching of transform precoding states, which would take effect between two PUSCH transmissions of a PUSCH repetition or a TBoMS, e.g., between PUSCH #1 and PUSCH #2 in FIG. 8. In response to receiving the signaling, the UE may perform different operations in different embodiments as below.

In some embodiments of FIG. 8, the UE may determine that the signaling does not take effect on all the PUSCH transmissions (i.e., PUSCH #1, PUSCH #2, PUSCH #3, and PUSCH #4 in FIG. 8), which means that the transform precoding states of PUSCH #2, PUSCH #3, and PUSCH #4 are kept the same as the transform precoding state of PUSCH #1. In these embodiments, assuming that there is a new PUSCH transmission (not shown in FIG. 8) after PUSCH #4, the signaling could take effect after the end of PUSCH #4. Then, the new transform precoding state (e.g., transform precoding state #2) indicated by the signaling could be used for the new PUSCH transmission after PUSCH #4.

In some further embodiments of FIG. 8, the UE may determine that the signaling takes effect on the PUSCH transmissions from PUSCH #2, i.e., the signaling takes effect for all of PUSCH #2, PUSCH #3, and PUSCH #4. In these embodiments, at least one of following transmission parameters for any of PUSCH #2, PUSCH #3, and PUSCH #4 may be re-determined according to the transform precoding state indicated by the signaling: Frequency domain resource assignment type, Frequency hopping flag, SRS resource indicator, Second SRS resource indicator, Precoding information and number of layers, Antenna ports, PTRS-DMRS association, beta_offset indicator, DMRS sequence initialization. In an embodiment, all of these parameters for PUSCH #2, PUSCH #3, and/or PUSCH #4 could be different from those for PUSCH #1. In another embodiment, some of these parameters for PUSCH #2, PUSCH #3, and/or PUSCH #4 are kept the same as those for PUSCH #1, while other parameters within these parameters for PUSCH #2, PUSCH #3, and/or PUSCH #4 are different from those for PUSCH #1.

In some other embodiments of FIG. 8, the UE may receive an indication to indicate that the signaling should take effect. Then, the UE may determine that the signaling takes effect on the PUSCH transmissions from PUSCH #2, i.e., the signaling takes effect for all of PUSCH #2, PUSCH #3, and PUSCH #4. In these embodiments, at least one of following transmission parameters for any of PUSCH #2, PUSCH #3, and PUSCH #4 may be re-determined according to the transform precoding state indicated by the signaling: Frequency domain resource assignment type, Frequency hopping flag, SRS resource indicator, Second SRS resource indicator, Precoding information and number of layers, Antenna ports, PTRS-DMRS association, beta_offset indicator, DMRS sequence initialization. In an embodiment, all of these parameters for PUSCH #2, PUSCH #3, and/or PUSCH #4 could be different from those for PUSCH #1. In another embodiment, some of these parameters for PUSCH #2, PUSCH #3, and/or PUSCH #4 are kept the same as those for PUSCH #1, while other parameters within these parameters for PUSCH #2, PUSCH #3, and/or PUSCH #4 are different from those for PUSCH #1.

In some additional embodiments of FIG. 8, the UE may receive an indication to indicate that the signaling should not take effect. Then, the UE may determine that the signaling does not take effect on the PUSCH transmissions from PUSCH #2, i.e., the signaling does not take effect for PUSCH #2, PUSCH #3, and PUSCH #4.

In some additional embodiments of FIG. 8, the UE may determine that the frequency domain resource assignment type for PUSCH #1 is resource allocation type 0. Then, the UE may determine that the signaling does not take effect. Otherwise, if the UE determines that the frequency domain resource assignment type for PUSCH #1 is not resource allocation type 0, the UE may determine that the signaling takes effect.

In some additional embodiments of FIG. 8, the UE may determine that DMRS scrambling IDs for transform precoding state #1 and transform precoding state #2 are different. Then, the UE may determine that the signaling does not take effect. Otherwise, if the UE determines that the DMRS scrambling IDs for transform precoding state #1 and transform precoding state #2 are the same, the UE may determine that the signaling takes effect.

In some additional embodiments of FIG. 8, the UE may determine that values of DMRS sequence initialization for transform precoding state #1 and transform precoding state #2 are different. Then, the UE may determine that the signaling does not take effect. Otherwise, if the UE determines that the values of DMRS sequence initialization for transform precoding state #1 and transform precoding state #2 are the same, the UE may determine that the signaling takes effect.

In some additional embodiments of FIG. 8, the UE may determine that MCS values for transform precoding state #1 and transform precoding state #2 are different. Then, the UE may determine that the signaling does not take effect. Otherwise, if the UE determines that the MCS values for transform precoding state #1 and transform precoding state #2 are the same, the UE may determine that the signaling takes effect.

In some additional embodiments of FIG. 8, the UE may determine that the at least one of following parameters for transform precoding state #1 and transform precoding state #2 are different: Frequency hopping flag, SRS resource indicator, Second SRS resource indicator, Precoding information and number of layers, Antenna ports, PTRS-DMRS association, and/or beta_offset indicator. Then, the UE may determine that the signaling does not take effect. Otherwise, if the UE determines that all of these parameters for transform precoding state #1 and transform precoding state #2 are the same, the UE may determine that the signaling takes effect.

Referring back to FIG. 7, in some embodiments of the present disclosure, the UE may determine one or more TDWs for bundling multiple DMRSs of PUSCH transmissions of the PUSCH repetition or the TBoMS by taking the switching from transform precoding state #1 to transform precoding state #2 as “an event” which causes power consistency and phase continuity not to be maintained across any two consecutive PUSCH transmissions of the PUSCH repetition or the TBoMS. In some embodiments, the UE may take the switching from transform precoding state #1 to transform precoding state #2 as “a semi static event” or “a dynamic event”.

For instance, the UE may take the switching between two transform precoding states in response to the signaling indicating the transform precoding state switching between any two consecutive PUSCH transmissions as “a semi static event”. In an embodiment:
(1) In case that an actual TDW is created in response to frequency hopping or in response to any event not triggered by DCI or MAC-CE, or in response to transform precoding state switching, the UE shall maintain power consistency and phase continuity within an actual TDW, across PUSCH transmissions of PUSCH repetition Type A scheduled by DCI format 0_1 or 0_2, or PUSCH repetition Type A with a CG, or PUSCH repetition Type B or TBoMS, or across PUCCH transmissions of the PUCCH repetition.
(2) In case that an actual TDW is created in response to “an event” triggered by DCI other than frequency hopping and transform precoding state switching or by MAC-CE, whether the UE maintains power consistency and phase continuity within an actual TDW, across PUSCH transmissions of PUSCH repetition Type A scheduled by DCI format 0_1 or 0_2, or PUSCH repetition Type A with a CG, or PUSCH repetition Type B or TBoMS, or across PUCCH transmissions of the PUCCH repetition, depends upon the UE's capability.

For instance, the UE may take the switching between two transform precoding states in response to the signaling indicating the transform precoding state switching between any two consecutive PUSCH transmissions as “a dynamic event”. In an embodiment:
(1) In case that an actual TDW is created in response to frequency hopping or in response to any event not triggered by DCI or MAC-CE, the UE shall maintain power consistency and phase continuity within an actual TDW, across PUSCH transmissions of PUSCH repetition Type A scheduled by DCI format 0_1 or 0_2, or PUSCH repetition Type A with a CG, or PUSCH repetition Type B or TBoMS, or across PUCCH transmissions of the PUCCH repetition.
(2) In case that an actual TDW is created in response to “an event” triggered by DCI other than frequency hopping or by MAC-CE, whether the UE maintains power consistency and phase continuity within an actual TDW, across PUSCH transmissions of PUSCH repetition Type A scheduled by DCI format 0_1 or 0_2, or PUSCH repetition Type A with a CG, or PUSCH repetition Type B or TBoMS, or across PUCCH transmissions of the PUCCH repetition, depends upon the UE's capability.

In some embodiments of the present disclosure, the UE may determine whether a set of conditions is fulfilled. In response to fulfillment of this set of conditions, the UE may determine to take the switching from transform precoding state #1 to transform precoding state #2 as “an event” which causes power consistency and phase continuity not to be maintained across any two consecutive PUSCH transmissions of the PUSCH repetition or the TBoMS. For example, the UE may determine whether certain parameter(s) within this set of parameters for transform precoding state #1 and transform precoding state #2 are the same or not, and then determine whether the transform precoding state switching is “an event” based on whether the certain parameter(s) are the same or not. In an embodiment, this set of conditions may include at least one of:
(1) Reception of an indication for indicating that the switching from transform precoding state #1 to transform precoding state #2 is “an event”. For instance, the UE may receive an indication from the network node by RRC signaling or DCI, which could indicate whether the transform precoding state switching is an event or not.
(2) A frequency domain resource assignment type of “the first PUSCH transmission of the PUSCH repetition or the TBoMS” (i.e., the initial frequency domain resource assignment type) is resource allocation type 0. For instance, if the initial frequency domain resource allocation type is resource allocation type 0, the transform precoding state switching is an event; otherwise, the transform precoding state switching is not an event.
(3) A DMRS scrambling ID for transform precoding state #1 is different from a DMRS scrambling ID for transform precoding state #2. For instance, if the DMRS scrambling IDs for these two transform precoding states are the same, the transform precoding state switching is not an event; otherwise, the transform precoding state switching is an event.
(4) A value of DMRS sequence initialization for transform precoding state #1 is different from a value of DMRS sequence initialization for transform precoding state #2. For instance, if the values of DMRS sequence initialization for these two transform precoding states are the same, the transform precoding state switching is not an event; otherwise, the transform precoding state switching is an event.
(5) A MCS value for transform precoding state #1 is different from a MCS value for transform precoding state #2. For instance, if the MCS values for these two transform precoding states are the same, the transform precoding state switching is not an event; otherwise, the transform precoding state switching is an event.
(6) A frequency hopping flag for transform precoding state #1 is different from a frequency hopping flag for transform precoding state #2. For instance, if the frequency hopping flags for these two transform precoding states are the same, the transform precoding state switching is not an event; otherwise, the transform precoding state switching is an event.
(7) A SRS resource indicator for transform precoding state #1 is different from a SRS resource indicator for transform precoding state #2. For instance, if the SRS resource indicators for these two transform precoding states are the same, the transform precoding state switching is not an event; otherwise, the transform precoding state switching is an event.
(8) A second SRS resource indicator for transform precoding state #1 is different from a second SRS resource indicator for transform precoding state #2. For instance, if the second SRS resource indicators for these two transform precoding states are the same, the transform precoding state switching is not an event; otherwise, the transform precoding state switching is an event.
(9) Precoding information and a number of layers for transform precoding state #1 is different from precoding information and a number of layers for transform precoding state #2. For instance, if the precoding information and the numbers of layers for these two transform precoding states are the same, the transform precoding state switching is not an event; otherwise, the transform precoding state switching is an event.
(10) One or more antenna ports for transform precoding state #1 are different from one or more antenna ports for transform precoding state #2. For instance, if the antenna ports for these two transform precoding states are the same, the transform precoding state switching is not an event; otherwise, the transform precoding state switching is an event.
(11) A PTRS-DMRS association for transform precoding state #1 is different from a PTRS-DMRS association for transform precoding state #2. For instance, if the PTRS-DMRS associations for these two transform precoding states are the same, the transform precoding state switching is not an event; otherwise, the transform precoding state switching is an event.
(12) A beta offset indicator (e.g., beta_offset indicator) for transform precoding state #1 is different from a beta offset indicator for transform precoding state #2. For instance, if the beta offset indicators for these two transform precoding states are the same, the transform precoding state switching is not an event; otherwise, the transform precoding state switching is an event.

With reference to FIG. 6, as described above, the embodiments of FIG. 6 assume that the duration of nominal TDW #1 or nominal TDW #2 is configured to 2 slots and PUSCH transmissions are transmitted in 4 slots (i.e., Slot #0 to Slot #3) with PUSCH repetition Type A or repetition Type B. In the embodiments of FIG. 6, in nominal TDW #1, there is one actual TDW (i.e., actual TDW #1) from the start symbol of the first PUSCH transmission to the end symbol of the second PUSCH transmission. In nominal TDW #2, there may be following different embodiments of FIG. 6 in different scenarios.

Specifically, in some embodiments of FIG. 6, the UE may take switching of transform precoding states as “an event”. In nominal TDW #2, if “an event” of switching from transform precoding state #1 to transform precoding state #2 in response to the signaling indicating the transform precoding state switching occurs, there could be two actual TDWs (i.e., actual TDW #2 and actual TDW #3).

In some other embodiments of FIG. 6, the UE may receive an indication to indicate that switching of transform precoding states should be an event. In nominal TDW #2, if “an event” of switching from transform precoding state #1 to transform precoding state #2 in response to the signaling indicating the transform precoding state switching occurs, there could be two actual TDWs (i.e., actual TDW #2 and actual TDW #3).

In some other embodiments of FIG. 6, the UE may determine that the frequency domain resource assignment type for PUSCH #1 is resource allocation type 0. Then, the UE may determine that the transform precoding state switching is an event. In nominal TDW #2, if “an event” of switching from transform precoding state #1 to transform precoding state #2 in response to the signaling indicating the transform precoding state switching occurs, there could be two actual TDWs (i.e., actual TDW #2 and actual TDW #3). Otherwise, if the UE determines that the frequency domain resource assignment type for PUSCH #1 is not resource allocation type 0, the UE may determine that the transform precoding state switching is not an event.

In some additional embodiments of FIG. 6, the UE may determine that DMRS scrambling IDs for transform precoding state #1 and transform precoding state #2 are different. Then, the UE may determine that the transform precoding state switching is an event. In nominal TDW #2, if “an event” of switching from transform precoding state #1 to transform precoding state #2 in response to the signaling indicating the transform precoding state switching occurs, there could be two actual TDWs (i.e., actual TDW #2 and actual TDW #3). Otherwise, if the UE determines that the DMRS scrambling IDs for transform precoding state #1 and transform precoding state #2 are the same, the UE may determine that the transform precoding state switching is not an event.

In some additional embodiments of FIG. 6, the UE may determine that values of DMRS sequence initialization for transform precoding state #1 and transform precoding state #2 are different. Then, the UE may determine that the transform precoding state switching is an event. In nominal TDW #2, if “an event” of switching from transform precoding state #1 to transform precoding state #2 in response to the signaling indicating the transform precoding state switching occurs, there could be two actual TDWs (i.e., actual TDW #2 and actual TDW #3). Otherwise, if the UE determines that the values of DMRS sequence initialization for transform precoding state #1 and transform precoding state #2 are the same, the UE may determine that the transform precoding state switching is not an event.

In some additional embodiments of FIG. 6, the UE may determine that MCS values for transform precoding state #1 and transform precoding state #2 are different. Then, the UE may determine that the transform precoding state switching is an event. In nominal TDW #2, if “an event” of switching from transform precoding state #1 to transform precoding state #2 in response to the signaling indicating the transform precoding state switching occurs, there could be two actual TDWs (i.e., actual TDW #2 and actual TDW #3). Otherwise, if the UE determines that the MCS values for transform precoding state #1 and transform precoding state #2 are the same, the UE may determine that the transform precoding state switching is not an event.

In some additional embodiments of FIG. 6, the UE may determine that at least one of following parameters for transform precoding state #1 and transform precoding state #2 are different: Frequency hopping flag, SRS resource indicator, Second SRS resource indicator, Precoding information and number of layers, Antenna ports, PTRS-DMRS association, and/or beta_offset indicator. Then, the UE may determine that the transform precoding state switching is an event. In nominal TDW #2, if “an event” of switching from transform precoding state #1 to transform precoding state #2 in response to the signaling indicating the transform precoding state switching occurs, there could be two actual TDWs (i.e., actual TDW #2 and actual TDW #3). Otherwise, if the UE determines that all of these parameters for transform precoding state #1 and transform precoding state #2 are the same, the UE may determine that the transform precoding state switching is not an event.

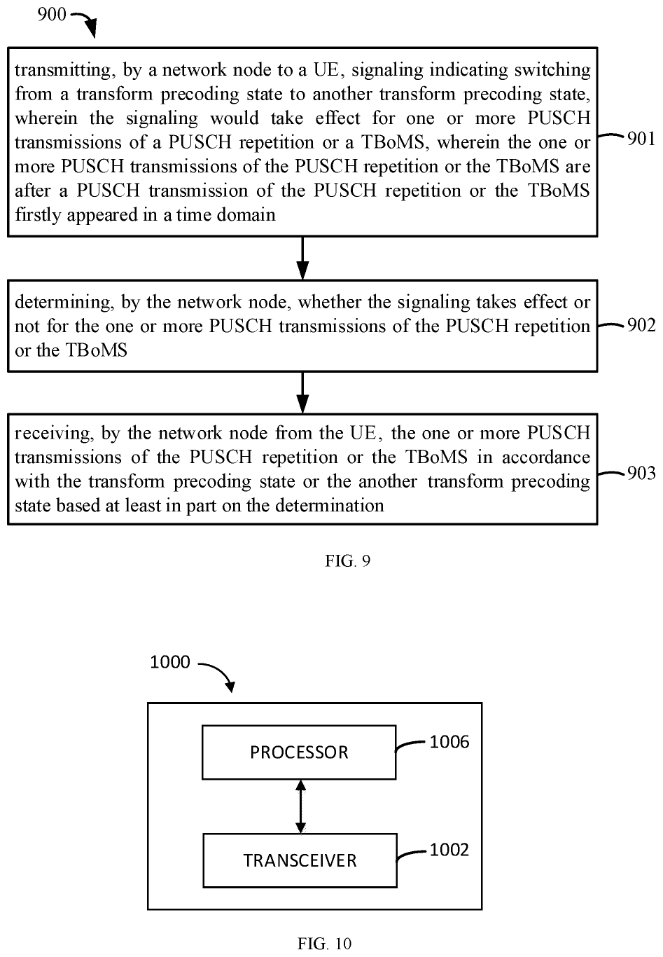

FIG. 9 illustrates a further flowchart of an exemplary procedure for switching transform precoding states according to some embodiments of the present disclosure. The method in FIG. 9 may be implemented by a network node (e.g., BS 102 in FIG. 1). Details described in all other embodiments of the present disclosure are applicable for the embodiments shown in FIG. 9.

In the exemplary procedure 900 shown in FIG. 9, in operation 901, a network node may transmit “signaling indicating switching from a transform precoding state (e.g., transform precoding state #1) to another transform precoding state (e.g., transform precoding state #2)” to a UE (e.g., UE 101 in FIG. 1). The descriptions regarding the signaling indicating the transform precoding state switching, transform precoding state #1, and transform precoding state #2 in the previous text (especially, with respect to FIGS. 7 and 8) may apply here.

The signaling would take effect for one or more PUSCH transmissions of a PUSCH repetition or a TBoMS or would take effect from one PUSCH transmission of the PUSCH repetition or the TBoMS. The one or more PUSCH transmissions or the one PUSCH transmission are after a PUSCH transmission of the PUSCH repetition or the TBoMS firstly appeared in a time domain (i.e., the first PUSCH transmission of the PUSCH repetition or the TBoMS). The descriptions regarding the one or more PUSCH transmissions, the one PUSCH transmission, the PUSCH repetition, and the TBoMS in the previous text (especially, with respect to FIGS. 7 and 8) may apply here.

In operation 902, the network node may determine whether the signaling takes effect or not for the one or more PUSCH transmissions of the PUSCH repetition or the TBoMS, or, the network node may determine whether the signaling takes effect or not from the one PUSCH transmission of the PUSCH repetition or the TBOMS. For instance, the network node may use the embodiments in FIG. 6 or FIG. 8 to determine whether the signaling takes effect or not. In operation 903, the network node may receive, from the UE, the one or more PUSCH transmissions of the PUSCH repetition or the TBoMS (e.g., PUSCH #1 to PUSCH #4 in FIG. 8) in accordance with transform precoding state #1 or transform precoding state #2 based at least in part on the determination in operation 902.

In some embodiments of FIG. 9, in response to transmitting two or more messages including the signaling which would take effect for the one or more PUSCH transmissions of the PUSCH repetition or the TBoMS or from the one PUSCH transmission of the PUSCH repetition or the TBoMS, the network node may only determine whether the signaling included in a message lastly transmitted by the network node within the two or more messages takes effect or not. The signaling included in the two or more messages other than the lastly transmitted message does not take effect.

In some embodiments of FIG. 9, in response to determining that the signaling takes effect, the network node may switch from transform precoding state #1 to transform precoding state #2 for the one or more PUSCH transmissions of the PUSCH repetition or the TBoMS or for the one PUSCH transmission. In response to determining that the signaling does not take effect, the network node may receive the one or more PUSCH transmissions of the PUSCH repetition or the TBoMS (e.g., PUSCH #1 to PUSCH #4 in FIG. 8) without switching from transform precoding state #1 to transform precoding state #2.

In some embodiments of FIG. 9, the network node may determine that the signaling does not take effect for the one or more PUSCH transmissions of the PUSCH repetition or the TBoMS, or the network node may determine that the signaling does not take effect from the one PUSCH transmission of the PUSCH repetition or the TBoMS. In an embodiment, in response to determining that the signaling does not take effect, the signaling takes effect after a last PUSCH transmission of the PUSCH repetition or the TBoMS (e.g., PUSCH #4 in FIG. 8). In some further embodiments of FIG. 9, the network node may ignore the signaling. In some other embodiments of FIG. 9, the network node may determine that the signaling takes effect for the one or more PUSCH transmissions of the PUSCH repetition or the TBoMS (e.g., PUSCH #2 to PUSCH #4 in FIG. 8), or the network node may determine that the signaling takes effect from the one PUSCH transmission of the PUSCH repetition or the TBOMS.

In some embodiments of FIG. 9, in response to determining that the signaling takes effect for the one or more PUSCH transmissions of the PUSCH repetition or the TBoMS, the network node may redetermine transmission parameter(s) for the one or more PUSCH transmissions of the PUSCH repetition or the TBoMS. In some embodiments of FIG. 9, in response to determining that the signaling takes effect from the one PUSCH transmission of the PUSCH repetition or the TBoMS, the network node may redetermine transmission parameter(s) for the one PUSCH transmission of the PUSCH repetition or the TBoMS. In an embodiment, the transmission parameter(s) include at least one of: a frequency domain resource assignment type; a frequency hopping flag; a SRS resource indicator; a second SRS resource indicator, precoding information and a number of layers; one or more antenna ports; a PTRS-DMRS association; a beta offset indicator; or a value of DMRS sequence initialization.

In other words, in some embodiments, at least one of the above parameters would be different for the one or more PUSCH transmissions and the first PUSCH transmission. In some embodiments, at least one of the above parameters would be different for the one PUSCH transmission and the first PUSCH transmission.

In some embodiments of FIG. 9, in response to determining that the signaling takes effect for the one or more PUSCH transmissions of the PUSCH repetition or the TBoMS, a set of transmission parameters for the one or more PUSCH transmissions may be the same as the set of transmission parameters for a PUSCH transmission of the PUSCH repetition or the TBoMS preceding the one or more PUSCH transmissions. In some embodiments of FIG. 9, in response to determining that the signaling takes effect from the one PUSCH transmission of the PUSCH repetition or the TBoMS, a set of transmission parameters for the one PUSCH transmission may be the same as the set of transmission parameters for a PUSCH transmission of the PUSCH repetition or the TBoMS preceding the one PUSCH transmission. In an embodiment, the set of transmission parameters includes at least one of: a frequency domain resource assignment type; a frequency hopping flag; a PTRS-DMRS association; a value of DMRS sequence initialization; or a MCS value.

In some embodiments of FIG. 9, the network node may determine whether a set of conditions is fulfilled or not before determining whether the signaling takes effect or not. In response to fulfillment of the set of conditions, the network node may determine that the signaling takes effect for the one or more PUSCH transmissions of the PUSCH repetition or the TBoMS or determine that the signaling takes effect from the one PUSCH transmission of the PUSCH repetition or the TBoMS. In an embodiment, the set of conditions includes at least one of:
(1) transmitting an indication for indicating that the signaling should take effect;
(2) a frequency domain resource assignment type of the first PUSCH transmission of the PUSCH repetition or the TBoMS (i.e., the initial frequency domain resource assignment type) is not resource allocation type 0;
(3) a DMRS scrambling ID for transform precoding state #1 is the same as a DMRS scrambling ID for transform precoding state #2;
(4) a value of DMRS sequence initialization for transform precoding state #1 is the same as a value of DMRS sequence initialization for transform precoding state #2;
(5) a MCS value for transform precoding state #1 is the same as a MCS value for transform precoding state #2;
(6) a frequency hopping flag for transform precoding state #1 is the same as a frequency hopping flag for transform precoding state #2;
(7) a SRS resource indicator for transform precoding state #1 is the same as a SRS resource indicator for transform precoding state #2;
(8) a second SRS resource indicator for transform precoding state #1 is the same as a second SRS resource indicator for transform precoding state #2;
(9) precoding information and a number of layers for transform precoding state #1 is the same as precoding information and a number of layers for transform precoding state #2;
(10) one or more antenna ports for transform precoding state #1 are the same as one or more antenna ports for transform precoding state #2;
(11) a PTRS-DMRS association for transform precoding state #1 is the same as a PTRS-DMRS association for transform precoding state #2; or
(12) a beta offset indicator for transform precoding state #1 is the same as a beta offset indicator for transform precoding state #2.

In some embodiments of FIG. 9, the network node may determine TDW(s) for bundling multiple DMRSs of PUSCH transmissions of the PUSCH repetition or the TBoMS by taking the switching from transform precoding state #1 to transform precoding state #2 as “an event” which causes power consistency and phase continuity not to be maintained across the PUSCH transmissions of the PUSCH repetition or the TBoMS. In an embodiment, the network node may take switching from transform precoding state #1 to transform precoding state #2 as “a semi static event” or “a dynamic event”.

For instance, the network node may take the switching between two transform precoding states in response to the signaling indicating the transform precoding state switching between any two consecutive PUSCH transmissions as “a semi static event”. Or, the network node may take the switching between two transform precoding states in response to the signaling indicating the transform precoding state switching between any two consecutive PUSCH transmissions as “a dynamic event”.

In some embodiments of FIG. 9, the network node may determine whether a set of conditions is fulfilled. In response to fulfillment of the set of conditions, the network node may determine to take the switching from transform precoding state #1 to transform precoding state #2 as “an event”. In some embodiments, the network node may use the embodiments in FIG. 6 or FIG. 8 to determine whether to take the switching between two transform precoding states as “an event” or not.

In an embodiment, the set of conditions includes at least one of:
(1) transmitting an indication for indicating that the switching from transform precoding state #1 to transform precoding state #2 is the event;
(2) a frequency domain resource assignment type of the first PUSCH transmission of the PUSCH repetition or the TBoMS (i.e., the initial frequency domain resource assignment type) is resource allocation type 0;
(3) a DMRS scrambling ID for transform precoding state #1 is different from a DMRS scrambling ID for transform precoding state #2;
(4) a value of DMRS sequence initialization for transform precoding state #1 is different from a value of DMRS sequence initialization for transform precoding state #2;
(5) a MCS value for transform precoding state #1 is different from a MCS value for transform precoding state #2;
(6) a frequency hopping flag for transform precoding state #1 is different from a frequency hopping flag for transform precoding state #2;
(7) a SRS resource indicator for transform precoding state #1 is different from a SRS resource indicator for transform precoding state #2;
(8) a second SRS resource indicator for transform precoding state #1 is different from a second SRS resource indicator for transform precoding state #2;
(9) precoding information and a number of layers for transform precoding state #1 are different from precoding information and a number of layers for transform precoding state #2;
(10) one or more antenna ports for transform precoding state #1 are different from one or more antenna ports for transform precoding state #2;
(11) a PTRS-DMRS association for transform precoding state #1 is different from a PTRS-DMRS association for transform precoding state #2; or
(12) a beta offset indicator for transform precoding state #1 is different from a beta offset indicator for transform precoding state #2.

In some embodiments of FIG. 9, the network node may transmit “an indication for indicating that the signaling should take effect” to the UE. In response to transmitting the indication, the network node may determine that the signaling takes effect for the one or more PUSCH transmissions of the PUSCH repetition or the TBoMS or determine that the signaling takes effect from the one PUSCH transmission of the PUSCH repetition or the TBOMS.

In some other embodiments of FIG. 9, the network node may transmit, to the UE, an indication for indicating that switching from transform precoding state #1 to transform precoding state #2 is “an event” which causes power consistency and phase continuity not to be maintained across any two consecutive PUSCH transmissions of the PUSCH repetition or the TBoMS. In response to transmitting the indication, the network node may determine to take the switching from transform precoding state #1 to transform precoding state #2 as “an event”.

FIG. 10 illustrates a block diagram of an exemplary apparatus 1000 according to some embodiments of the present disclosure. As shown in FIG. 10, the apparatus 1000 may include at least one processor 1006 and at least one transceiver 1002 coupled to the processor 1006. The apparatus 1000 may be a UE or a network node (e.g., a BS). Details described in all of the foregoing embodiments of the present disclosure are applicable for the embodiments shown in FIG. 10.

Although in this figure, elements such as the at least one transceiver 1002 and processor 1006 are described in the singular, the plural is contemplated unless a limitation to the singular is explicitly stated. In some embodiments of the present disclosure, the transceiver 1002 may be divided into two devices, such as a receiving circuitry and a transmitting circuitry. In some embodiments of the present disclosure, the apparatus 1000 may further include an input device, a memory, and/or other components.

In some embodiments of the present disclosure, the apparatus 1000 may be a UE. The transceiver 1002 and the processor 1006 may interact with each other so as to perform the operations with respect to the UE described in FIGS. 1-9. In some embodiments of the present disclosure, the apparatus 1000 may be a network node (e.g., a BS). The transceiver 1002 and the processor 1006 may interact with each other so as to perform the operations with respect to the network node described in FIGS. 1-9.

In some embodiments of the present disclosure, the apparatus 1000 may further include at least one non-transitory computer-readable medium.

For example, in some embodiments of the present disclosure, the non-transitory computer-readable medium may have stored thereon computer-executable instructions to cause the processor 1006 to implement the method with respect to the UE as described above. For example, the computer-executable instructions, when executed, cause the processor 1006 interacting with transceiver 1002 to perform the operations with respect to the UE described in FIGS. 1-9.

In some embodiments of the present disclosure, the non-transitory computer-readable medium may have stored thereon computer-executable instructions to cause the processor 1006 to implement the method with respect to the network node as described above. For example, the computer-executable instructions, when executed, cause the processor 1006 interacting with transceiver 1002 to perform the operations with respect to the network node described in FIGS. 1-9.

Those having ordinary skill in the art would understand that the operations or steps of a method described in connection with the aspects disclosed herein may be embodied directly in hardware, in a software module executed by a processor, or in a combination of the two. A software module may reside in RAM memory, flash memory, ROM memory, EPROM memory, EEPROM memory, registers, a hard disk, a removable disk, a CD-ROM, or any other form of storage medium known in the art. Additionally, in some aspects, the operations or steps of a method may reside as one or any combination or set of codes and/or instructions on a non-transitory computer-readable medium, which may be incorporated into a computer program product.

While this disclosure has been described with specific embodiments thereof, it is evident that many alternatives, modifications, and variations may be apparent to those skilled in the art. For example, various components of the embodiments may be interchanged, added, or substituted in other embodiments. Also, all of the elements of each figure are not necessary for the operation of the disclosed embodiments. For example, one of ordinary skill in the art of the disclosed embodiments would be enabled to make and use the teachings of the disclosure by simply employing the elements of the independent claims. Accordingly, embodiments of the disclosure as set forth herein are intended to be illustrative, not limiting. Various changes may be made without departing from the spirit and scope of the disclosure.

In this document, the terms “includes,” “including,” or any other variation thereof, are intended to cover a non-exclusive inclusion, such that a process, method, article, or apparatus that includes a list of elements does not include only those elements but may include other elements not expressly listed or inherent to such process, method, article, or apparatus. An element proceeded by “a,” “an,” or the like does not, without more constraints, preclude the existence of additional identical elements in the process, method, article, or apparatus that includes the element. Also, the term “another” is defined as at least a second or more. The term “having” and the like, as used herein, are defined as “including.” Expressions such as “A and/or B” or “at least one of A and B” may include any and all combinations of words enumerated along with the expression. For instance, the expression “A and/or B” or “at least one of A and B” may include A, B, or both A and B. The wording “the first,” “the second” or the like is only used to clearly illustrate the embodiments of the present disclosure, but is not used to limit the substance of the present disclosure.

1. A user equipment (UE), comprising:
at least one memory; and
at least one processor coupled with the at least one memory and configured to cause the UE to:
receive signaling indicating switching from a first transform precoding state to a second transform precoding state, wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain;
determine whether the signaling takes effect or not for the one or more PUSCH transmissions of the PUSCH repetition or the TBoMS; and
transmit the one or more PUSCH transmissions of the PUSCH repetition or the TBoMS in accordance with the first transform precoding state or the second transform precoding state based at least in part on the determination.

2. The UE of claim 1, wherein the first transform precoding state or the second transform precoding state is one of an enabled state and a disabled state.

3. The UE of claim 1, wherein, to determine whether the signaling takes effect or not, the at least one processor of the UE is configured to cause the UE to perform one of:
determining that the signaling does not take effect for the one or more PUSCH transmissions of the PUSCH repetition or the TBoMS;
ignoring the signaling;
determining that the signaling takes effect for the one or more PUSCH transmissions of the PUSCH repetition or the TBOMS.

4. The UE of claim 3, wherein, in response to determining that the signaling does not take effect, the signaling takes effect after a last PUSCH transmission of the PUSCH repetition or the TBoMS.

5. The UE of claim 3, wherein, in response to determining that the signaling takes effect for the one or more PUSCH transmissions of the PUSCH repetition or the TBoMS, the at least one processor is configured to cause the UE to redetermine one or more transmission parameters for the one or more PUSCH transmissions of the PUSCH repetition or the TBoMS.

6. The UE of claim 5, wherein the one or more transmission parameters include at least one of:
a frequency domain resource assignment type;
a frequency hopping flag;
a sounding reference signal (SRS) resource indicator;
a second SRS resource indicator;
precoding information and a number of layers;
one or more antenna ports;
a phase tracking reference signal demodulation reference signal (PTRS-DMRS) association;
a beta offset indicator; or
a value of demodulation reference signal (DMRS) sequence initialization.

7. The UE of claim 3, wherein, in response to determining that the signaling takes effect for the one or more PUSCH transmissions of the PUSCH repetition or the TBoMS, a first set of transmission parameters for the one or more PUSCH transmissions are same as a second set of transmission parameters for a PUSCH transmission of the PUSCH repetition or the TBoMS preceding the one or more PUSCH transmissions.

8. The UE of claim 1, wherein the at least one processor is configured to cause the UE to determine whether a first set of conditions is fulfilled or not before determining whether the signaling takes effect or not.

9. The UE of claim 8, wherein the first set of conditions includes at least one of:
reception of an indication for indicating that the signaling should take effect;
a frequency domain resource assignment type of the PUSCH transmission of the PUSCH repetition or the TBoMS firstly appeared in the time domain is not resource allocation type 0;
a demodulation reference signal (DMRS) scrambling identifier (ID) for the first transform precoding state is same as a DMRS scrambling ID for the second transform precoding state;
a value of DMRS sequence initialization for the first transform precoding state is same as a value of DMRS sequence initialization for the second transform precoding state;
a modulation and coding scheme (MCS) value for the first transform precoding state is same as a MCS value for the second transform precoding state;
a frequency hopping flag for the first transform precoding state is same as a frequency hopping flag for the second transform precoding state;
a SRS resource indicator for the first transform precoding state is same as a SRS resource indicator for the second transform precoding state;
a second SRS resource indicator for the first transform precoding state is same as a second SRS resource indicator for the second transform precoding state;
precoding information and a number of layers for the first transform precoding state is same as precoding information and a number of layers for the second transform precoding state;
one or more antenna ports for the first transform precoding state are same as one or more antenna ports for the second transform precoding state;
a PTRS-DMRS association for the first transform precoding state is same as a PTRS-DMRS association for the second transform precoding state; or
a beta offset indicator for the first transform precoding state is same as a beta offset indicator for the second transform precoding state.

10. The UE of claim 1, wherein the at least one processor is configured to cause the UE to:
determine one or more time domain windows (TDW) s for bundling multiple demodulation reference signals (DMRS) s of PUSCH transmissions of the PUSCH repetition or the TBoMS by taking the switching from the first transform precoding state to the second transform precoding state as an event which causes power consistency and phase continuity not to be maintained across the PUSCH transmissions of the PUSCH repetition or the TBoMS.

11. The UE of claim 10, wherein the at least one processor is configured to cause the UE to take the switching from the first transform precoding state to the second transform precoding state as a semi static event or a dynamic event.

12. The UE of claim 10, wherein the at least one processor is configured to cause the UE to:
determine whether a second set of conditions is fulfilled; and
in response to fulfillment of the second set of conditions, determine to take the switching from the first transform precoding state to the second transform precoding state as the event.

13. A network node, comprising:
at least one memory; and
at least one processor coupled with the at least one memory and configured to cause the network node to:
transmit signaling indicating switching from a first transform precoding state to a second transform precoding state to a user equipment (UE), wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain;
determine whether the signaling takes effect or not for the one or more PUSCH transmissions of the PUSCH repetition or the TBoMS; and
receive the one or more PUSCH transmissions of the PUSCH repetition or the TBoMS in accordance with the first transform precoding state or the second transform precoding state based at least in part on the determination from the UE.

14. The network node of claim 13, wherein, to determine whether the signaling takes effect or not, the at least one processor is configured to cause the network node to perform one of:
determining that the signaling does not take effect for the one or more PUSCH transmissions of the PUSCH repetition or the TBoMS;
ignoring the signaling;
determining that the signaling takes effect for the one or more PUSCH transmissions of the PUSCH repetition or the TBoMS.

15. A method performed by a user equipment (UE), the method comprising:
receiving signaling indicating switching from a first transform precoding state to a second transform precoding state, wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain;
determining whether the signaling takes effect or not for the one or more PUSCH transmissions of the PUSCH repetition or the TBoMS; and
transmitting the one or more PUSCH transmissions of the PUSCH repetition or the TBoMS in accordance with the first transform precoding state or the second transform precoding state based at least in part on the determination.

16. A processor for wireless communication, comprising:
at least one controller coupled with at least one memory and configured to cause the processor to:
receive signaling indicating switching from a first transform precoding state to a second transform precoding state, wherein the signaling would take effect for one or more physical uplink shared channel (PUSCH) transmissions of a PUSCH repetition or a transmission block processing over multiple slots (TBoMS), wherein the one or more PUSCH transmissions of the PUSCH repetition or the TBoMS are after a PUSCH transmission of the PUSCH repetition or the TBoMS firstly appeared in a time domain;
determine whether the signaling takes effect or not for the one or more PUSCH transmissions of the PUSCH repetition or the TBoMS; and
transmit the one or more PUSCH transmissions of the PUSCH repetition or the TBoMS in accordance with the first transform precoding state or the second transform precoding state based at least in part on the determination.

17. The processor of claim 16, wherein the first transform precoding state or the second transform precoding state is one of an enabled state and a disabled state.

18. The processor of claim 16, wherein, to determine whether the signaling takes effect or not, the at least one controller is configured to cause the processor to perform one of:
determining that the signaling does not take effect for the one or more PUSCH transmissions of the PUSCH repetition or the TBoMS;
ignoring the signaling;
determining that the signaling takes effect for the one or more PUSCH transmissions of the PUSCH repetition or the TBoMS.

19. The processor of claim 18, wherein, in response to determining that the signaling does not take effect, the signaling takes effect after a last PUSCH transmission of the PUSCH repetition or the TBoMS.

20. The processor of claim 18, wherein, in response to determining that the signaling takes effect for the one or more PUSCH transmissions of the PUSCH repetition or the TBoMS, the at least one controller is configured to cause the processor to redetermine one or more transmission parameters for the one or more PUSCH transmissions of the PUSCH repetition or the TBoMS.
